(19) United States
(12) Patent Application Publication
(10) Pub. No.: US 2026/0029258 A1
(43) Pub. Date: Jan. 29, 2026

(54) MOUNTING METHOD OF ROTARY ENCODER, COMPUTER-READABLE NON-TRANSITORY MEDIUM, AND MOUNTING SUPPORT DEVICE OF ROTARY ENCODER

(71) Applicant: MITUTOYO CORPORATION, Kanagawa (JP)

(72) Inventors: Motohiro OSAKI, Tokyo (JP); Makoto KAIEDA, Miyazaki (JP); Shingo TAKEUCHI, Kanagawa (JP); Hiroyuki SOTOME, Tochigi (JP)

(73) Assignee: MITUTOYO CORPORATION, Kanagawa (JP)

(21) Appl. No.: 19/272,576

(22) Filed: Jul. 17, 2025

(30) Foreign Application Priority Data
Jul. 24, 2024 (JP) 2024-118922

(51) Int. Cl. G01D 11/30

(52) U.S. Cl. CPC G01D 11/30; G01D 2205/20

(57) ABSTRACT

A mounting includes rotating the rotor and acquiring an amount of eccentricity, an eccentric direction, an amount of tilt, and a direction of tilt of the rotor with respect to a device rotation axis, an amount of eccentricity, an eccentric direction, an amount of tilt, and a direction of tilt of the stator with respect to the device rotation axis, based on the detection value detected by the detection head provided on the stator, moving the stator with respect to the device rotation axis so that the amount of eccentric of the stator is within the allowable range, and moving the stator so that the distance between the stator and the rotor at a position where the rotor is attached to the device body, and the amount of tilt and the direction of tilt with respect to the device rotation axis are within the allowable range.

### CROSS-REFERENCE TO RELATED APPLICATION

This application is based upon and claims the benefit of priority of the prior Japanese Patent Application No. 2024-118922 filed on Jul. 24, 2024, the entire contents of which are incorporated herein by reference.

### FIELD

A certain aspect of embodiments described herein relates to a mounting method of a rotary encoder, a computer-readable non-transitory medium, and a mounting support device of a rotary encoder.

### BACKGROUND

Conventionally, a rotary encoder has been disclosed that includes a rotary scale having a scale pattern and a group of detection heads arranged opposite the rotary scale (see, for example, International Publication No. 2023/054613). The rotary scale is sometimes called a rotor. The group of detection heads is sometimes provided on a stator. The stator is attached to a device body of a device to which the rotary encoder is attached. Meanwhile, the rotor is attached, for example, to a rotating shaft member provided in the device.

### SUMMARY

In one aspect, the present invention aims to facilitate adjustment of a relative position between an equipment rotating shaft and the rotor, and a relative position between the equipment rotating shaft and the stator.

According to an aspect of the present invention, there is provided a mounting method of a rotary encoder for mounting the rotary encoder to a device including a device body and a device rotation shaft member rotatably provided with respect to the device body, the method including: temporarily attaching a stator included in the rotary encoder to the device body; fixing a rotor included in the rotary encoder to the rotation shaft member of the device so as to face the stator; acquiring a distance between the rotor and the stator, rotating the rotor and acquiring an amount of eccentricity, an eccentric direction, an amount of tilt, and a direction of tilt of the rotor with respect to a device rotation axis, which is a rotation axis of the device rotation shaft member, based on a detection value detected by a detection head provided on the stator; rotating the rotor and acquiring an amount of eccentricity, an eccentric direction, an amount of tilt, and a direction of tilt of the stator with respect to the device rotation axis, based on the detection value detected by the detection head provided on the stator; determining whether the amount of eccentric and the amount of tilt of the rotor are within an allowable range; moving the stator with respect to the device rotation axis so that the amount of eccentric of the stator is within the allowable range; and moving the stator so that the distance between the stator and the rotor at a position where the rotor is attached to the device body, and the amount of tilt and the direction of tilt with respect to the device rotation axis are within the allowable range.

According to another aspect of the present invention, there is provided a computer-readable, non-transitory medium storing a program for supporting in adjusting positions of a rotor and a stator disposed opposite the rotor, when attaching a rotary encoder to a device having a device body and a device rotation shaft member rotatably provided with respect to the device body, the program causing a computer to execute a process, the process including: calculating a distance between the rotor and the stator, calculating an amount of eccentricity, an eccentric direction, an amount of tilt, and a direction of tilt of the rotor with respect to a device rotation axis, which is a rotation axis of the device rotation shaft member, based on a detection value detected by a detection head provided on the stator, when rotating the rotor fixed to the device rotation shaft member; calculating an amount of eccentricity, an eccentric direction, an amount of tilt, and a direction of tilt of the stator with respect to the device rotation axis, based on the detection value detected by the detection head provided on the stator, when rotating the rotor fixed to the device rotation shaft member; displaying the amount of the eccentric and the direction of eccentric of the stator with respect to the device rotation axis on a displayer; and displaying the distance between the stator and the rotor at a position where the stator is attached to the device body on the displayer and displaying the amount of tilt and the direction of tilt with respect to the device rotation axis.

According to an aspect of the present invention, there is provided a mounting support device that supports in adjusting a position of a rotor included in a rotary encoder and a stator arranged opposite the rotor when mounting the rotary encoder on a device having a device body and a device rotation shaft member rotatably arranged with respect to the device body, including: an information processor configured to calculate a distance between the rotor and the stator, and calculate an amount of eccentricity, an eccentric direction, an amount of tilt, and a direction of tilt of the rotor with respect to a device rotation axis, which is a rotation axis of the device rotation shaft member, based on a detection value detected by a detection head provided on the stator attached to the device body when the rotor fixed to the device rotation shaft member is rotated, and calculate an amount of eccentricity, an eccentric direction, an amount of tilt, and a direction of tilt of the stator with respect to the device rotation axis, based on the detection value detected by the detection head provided on the stator attached to the device body when the rotor fixed to the device rotation shaft member is rotated; and a displayer configured to display the amount of eccentricity and the eccentric direction of the stator with respect to the device rotation axis calculated by the information processor, the distance between the stator and the rotor at a position where the stator is attached to the device body, and the amount of tilt and the direction of tilt with respect to the device rotation axis.

### BRIEF DESCRIPTION OF DRAWINGS

FIG. 1 is a block diagram illustrating a configuration of a mounting support system including a mounting support device according to an embodiment;

FIG. 2A is a side view illustrating a schematic diagram of a stator using a position adjustment mechanism before being mounted on a base;

FIG. 2B is a side view illustrating a schematic diagram of a stator using a position adjustment mechanism mounted on a base and a rotor mounted on a device rotation shaft member;

FIG. 2C is a side view illustrating a state in which a stator and a base part illustrated in FIG. 2A are upside down and swapped;

FIG. 2D is a side view illustrating a schematic diagram of a state in which a stator and a base part illustrated in FIG. 2B are upside down and a rotor is mounted on a device rotation shaft member;

FIG. 3 is a plan view illustrating a schematic diagram of a stator using a position adjustment mechanism mounted on a base part and a rotor mounted on a device rotation shaft member;

FIG. 4 is a plan view illustrating a schematic diagram of a rotary encoder to be installed according to an embodiment.

FIG. 5A is an explanatory diagram illustrating three degrees of freedom (X, Y, Z); FIG. 5B is an explanatory diagram illustrating a remaining three degrees of freedom (θx, θy, θz).

FIG. 6 is a plan view illustrating a detailed configuration of a rotary encoder illustrated in FIG. 4;

FIG. 7 is an explanatory diagram illustrating how a rotor and a stator are arranged opposite each other;

FIG. 8 is an explanatory diagram illustrating an arrangement of first to fourth detection heads on a stator;

FIG. 9 is a plan view of a rotor;

FIG. 10 is an explanatory diagram illustrating a configuration of a reception coil;

FIG. 11 is an explanatory diagram illustrating an example of a reception coil formed on a printed wiring board;

FIG. 12A is an explanatory diagram illustrating a state in which a stator with two detection heads is eccentric along a Y-axis direction;

FIG. 12B is an explanatory diagram illustrating a state in which a stator with two detection heads is eccentric along an X-axis direction;

FIG. 13A is an explanatory diagram illustrating a state in which a stator with two detection heads is rotated about a Y-axis;

FIG. 13B is an explanatory diagram illustrating a state in which a stator with two detection heads is rotated about an X-axis.

FIG. 14 is a diagram illustrating a correlation between a distance between detection heads and a rotor, and a strength of a detection signal;

FIG. 15 is an explanatory diagram illustrating a state in which a stator with four detection heads is eccentric along a Y-axis direction and along an X-axis direction.

FIG. 16 is an explanatory diagram that illustrates a stator equipped with four detection heads when rotated around a Y axis and when rotated around an X axis;

FIG. 17A is an explanatory diagram that illustrates n detection heads and a

FIG. 17B is an example of a sine wave drawn when detecting eccentricity in an X-axis direction and a Y-axis direction;

FIG. 17C is an example of a sine wave drawn when detecting θx and θy;

FIG. 18A is an explanatory diagram illustrating a relationship between an amount of eccentricity in an X-axis direction and a coefficient of a sine wave;

FIG. 18B is an explanatory diagram illustrating a relationship between an amount of eccentricity in a Y-axis direction and a coefficient of a sine wave;

FIG. 18C is an explanatory diagram illustrating a relationship between an angle of rotation about an X-axis and a coefficient of a sine wave; rotor;

FIG. 18D is an explanatory diagram illustrating a relationship between an angle of rotation about a Y-axis and a coefficient of a sine wave;

FIG. 19A is an exploded side view of a position adjustment mechanism;

FIG. 19B is a side view of a position adjustment mechanism;

FIG. 20 is a cross-sectional view taken along a line A-A in FIG. 3;

FIG. 21A is an oblique view of In adjustment tool separated into a first socket member and a second socket member;

FIG. 21B is an oblique view illustrating an adjustment tool and a hexagonal wrench;

FIG. 22A is a front view of a first socket member;

FIG. 22B is a plan view of a first socket member;

FIG. 22C is a bottom view of a first socket member;

FIG. 23A is a front view of a second socket member;

FIG. 23B is a plan view of a second socket member;

FIG. 23C is a side view of a second socket member;

FIG. 23D is a bottom view of a second socket member;

FIG. 24A is a cross-sectional view of an adjustment tool separated into a first socket member and a second socket member;

FIG. 24B is a cross-sectional view of an adjustment tool and a diagram illustrating a hexagonal wrench;

FIG. 25 is a cross-sectional view of an adjustment tool attached to a position adjustment mechanism;

FIG. 26A is a flow chart illustrating an example of a preparatory process in a mounting work of a rotary encoder;

FIG. 26B is a flow chart illustrating an example of a mounting support for a rotary encoder;

FIG. 27A is a diagram illustrating an example of a method for provisionally aligning eccentricity of a rotor and a stator;

FIG. 27B is a plan view of a positioning jig that can be used for provisionally aligning eccentricity of a rotor and a stator;

FIG. 27C is a front view of a positioning jig;

FIG. 28 is a diagram illustrating an example of a screen display in a mounting support;

FIG. 29A is an explanatory diagram illustrating a relationship between an arc trajectory traced by a center point of an eccentric rotor and an axis of rotation of a device;

FIG. 29B is an explanatory diagram illustrating a direction and a distance of movement of a stator;

FIG. 30 is an explanatory diagram illustrating a relationship between a position of a detection head and a position of a position adjustment mechanism;

FIG. 31 is a diagram illustrating an example of a screen display during gap adjustment and eccentricity adjustment; and

FIG. 32 is a diagram illustrating an example of a screen display instructing final confirmation of a mounting work.

### DESCRIPTION OF EMBODIMENTS

In order for a rotary encoder to perform accurate measurements, it is necessary to adjust the relative positions of the equipment's rotating shaft, which is the rotating shaft of the equipment's rotating shaft member, and the rotor, as well as the relative positions of the equipment's rotating shaft and the stator. However, such adjustment work takes time even when performed by a skilled operator. Furthermore, if the equipment to which the rotary encoder is attached is large or is installed on the ground, the rotary encoder may need to be installed on-site where the equipment is installed. In such cases, it is not always possible for a skilled operator to perform the adjustment work. Furthermore, it is desirable for the work on-site to be completed as quickly as possible.

A description will be given of embodiments with reference to drawings.

### Embodiment

### Mounting Support System

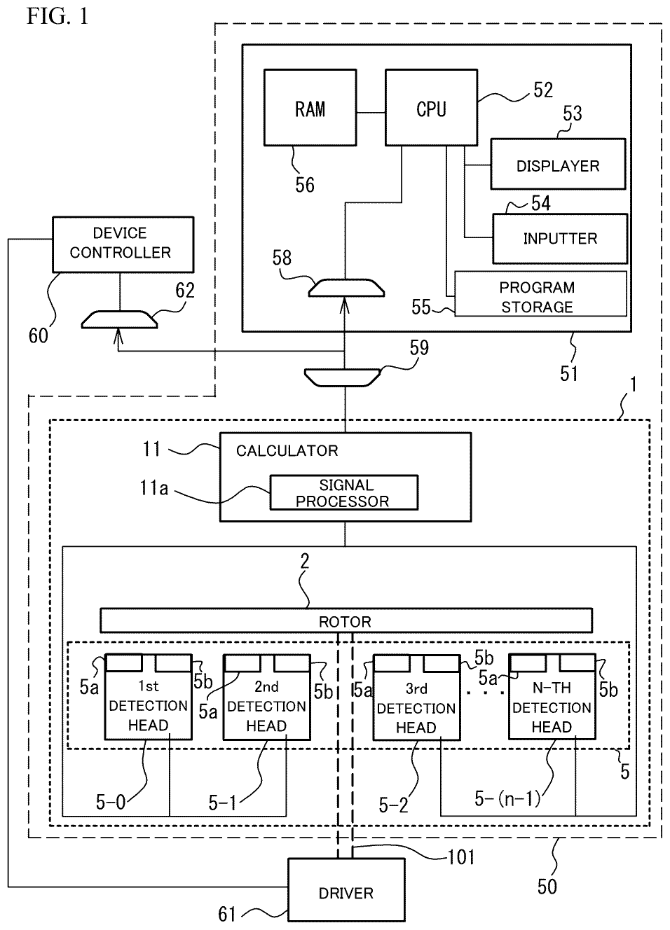

Referring to FIG. 1, a mounting support system 50 includes a rotary encoder 1 and a mounting support device 51.

### Rotary Encoder

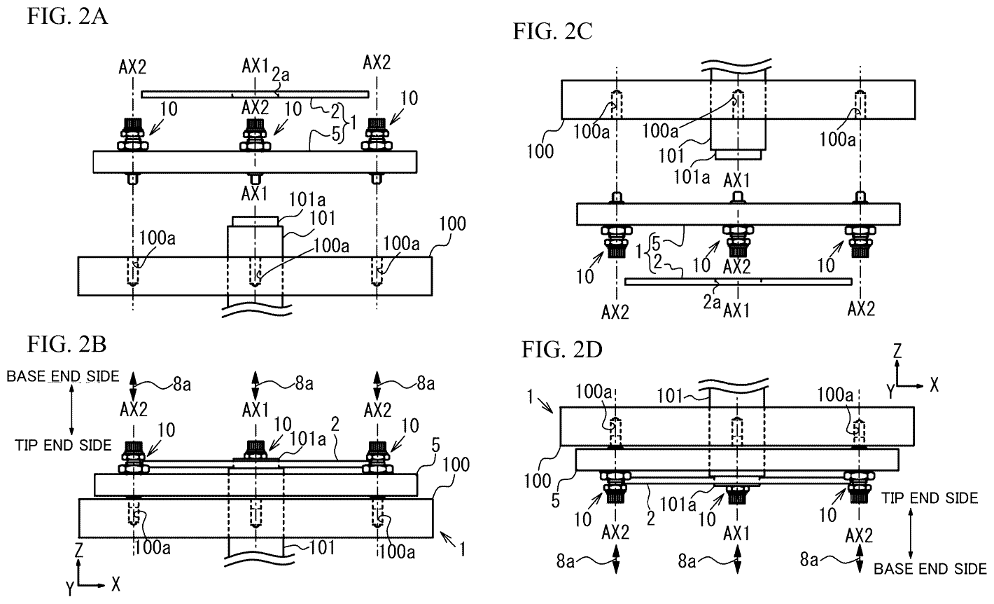

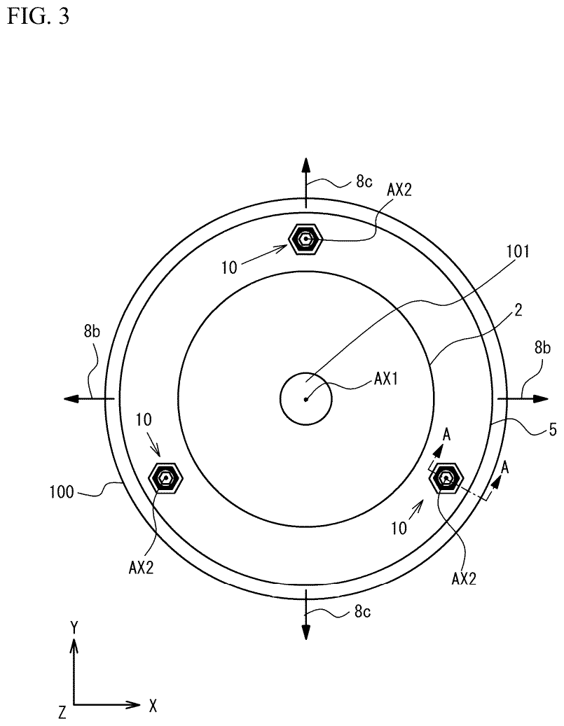

First, referring to FIG. 2A to FIG. 3, the rotary encoder 1 including a stator 5 will be described. The rotary encoder 1 includes a rotor 2 and the stator 5. The rotary encoder 1 is installed in, for example, various devices equipped with a rotating part. These devices include a base part 100 that is a device body, and a device rotation shaft member 101 that is rotatably provided with respect to the base part 100. The rotation axis of this device rotation shaft member 101 is a device rotation axis AX1. The stator 5 is attached to the base part 100. At this time, a position adjustment mechanism 10 is used, and the position can be adjusted by the position adjustment mechanism 10.

The rotor 2 has a scale pattern (not illustrated). The rotor 2 is a disk-shaped member with a fitting hole 2a in the center thereof. The rotor 2 is attached to the device rotation shaft member 101 by fitting the fitting hole 2a into the device rotation shaft member 101 so that the central axis of the rotor 2 coincides with the device rotation axis AX1 of the device rotation shaft member 101. The rotor 2 is required to be installed without eccentricity with respect to the device rotation axis AX1, and without tilting. The mounting support device 51 of this embodiment can determine whether the eccentricity and tilt of the rotor 2 with respect to the device rotation axis AX1 are within the allowable range.

The stator 5 is equipped with a transmitting/receiving unit that transmits and receives signals to and from the scale pattern. The stator 5 is attached to the base part 100. At this time, the stator 5 is required to be installed without eccentricity with respect to the device rotation axis AX1, and without tilting.

In this embodiment, the position of the stator 5 can be adjusted by the position adjustment mechanism 10. The mounting support device 51 also supports in the mounting of the rotor 2 and the stator 5.

In this embodiment, the stator 5 is located below the rotor 2, that is, on the negative (−) side in the Z-axis direction, but the stator 5 may also be located above the rotor 2.

The position adjustment mechanism 10 is arranged at equal intervals in the circumferential direction on the stator 5, spaced 120° apart. The stator 5 is attached to the base part 100 by screwing the position adjustment mechanism 10 into a screw hole 100a provided in the base part 100.

Each position of the position adjustment mechanisms 10 can move the point on the stator 5 where the position adjustment mechanism 10 is arranged up and down in the Z-axis direction, as illustrated by an arrow 8a in FIG. 2B. This allows the stator 5 to be installed in a plane orthogonal to the device rotation axis AX1.

Each of the position adjustment mechanisms 10 can move the stator 5 relative to a central axis AX2 of the screw hole 100a by being loosened. Therefore, each of the position adjustment mechanisms 10 can move the stator 5 along the X-axis direction, as illustrated by an arrow 8b in FIG. 3, and along the Y-axis direction, as illustrated by an arrow 8c. This allows the stator 5 to be installed without being eccentric with respect to the device rotation axis AX1.

In the following explanation, one side in the Z-axis direction will be referred to as the base end side and the other side as the tip side, as illustrated in FIG. 2B.

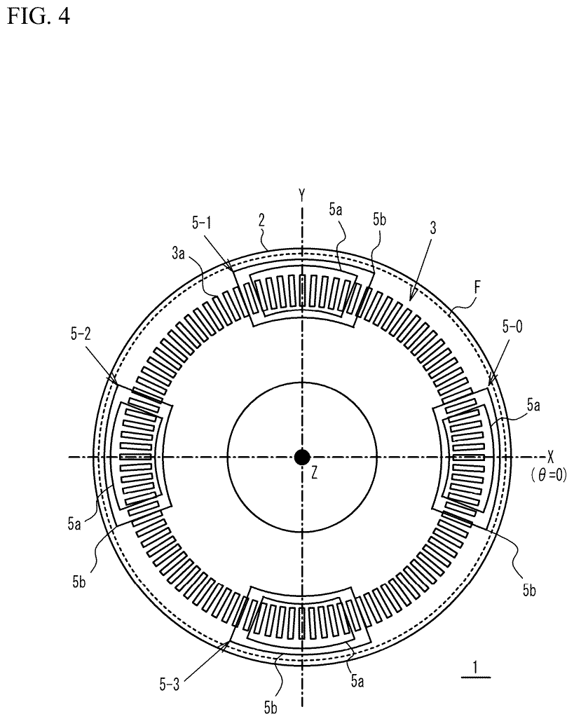

Here, an example configuration of the rotary encoder 1 will be explained in further detail with reference to FIG. 1, and FIG. 4 to FIG. 11.

Referring to FIG. 1, the rotary encoder 1 includes the rotor 2 and the stator 5, and n (n is an integer of 2 or more) detection heads 5-0 to 5-(n-1) are provided on the stator 5.

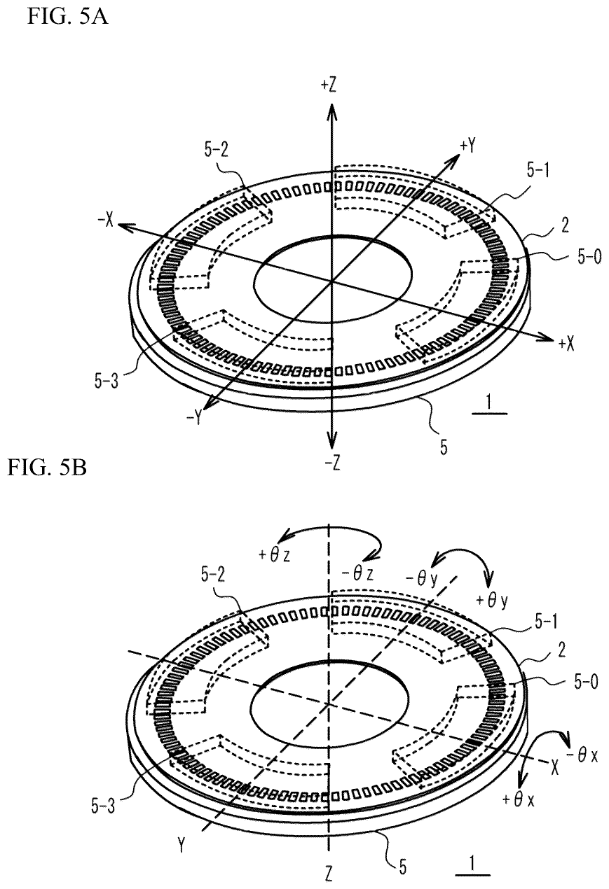

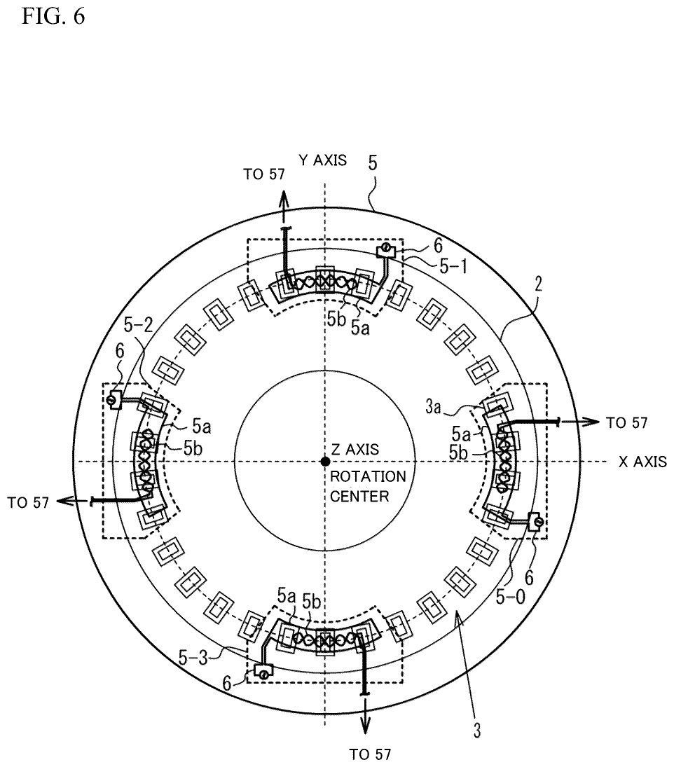

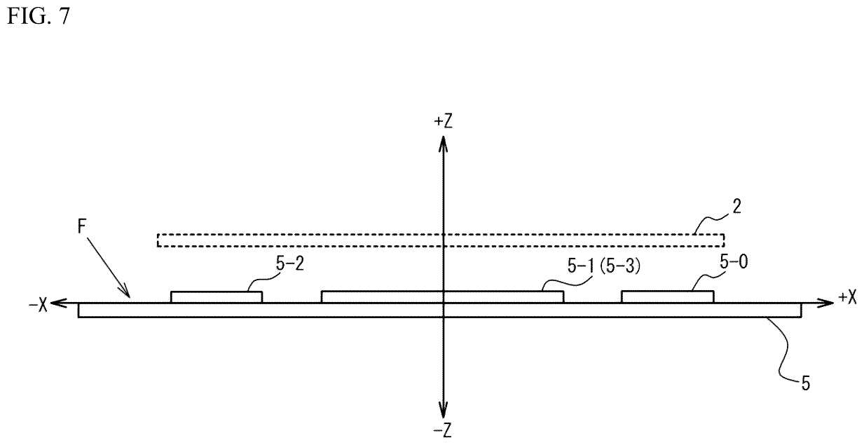

The rotary encoder 1 is illustrated in FIG. 4, FIG. 5A, FIG. 5B, FIG. 6, and FIG. 7. FIG. 4 is a plan view of the schematic configuration of the rotary encoder 1. FIG. 5A is an explanatory diagram of three degrees of freedom (X, Y, Z), and FIG. 5B is an explanatory diagram of the remaining three degrees of freedom (θx, θy, θz). FIG. 6 is a plan view of the details of the configuration of the rotary encoder illustrated in FIG. 4.

FIG. 7 is an explanatory diagram illustrating how the rotor and stator are arranged opposite to each other.

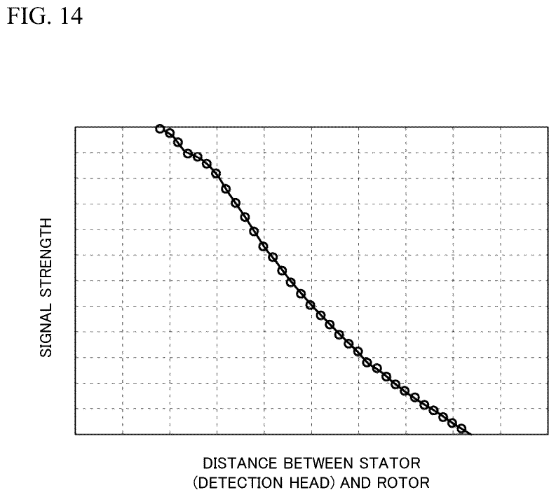

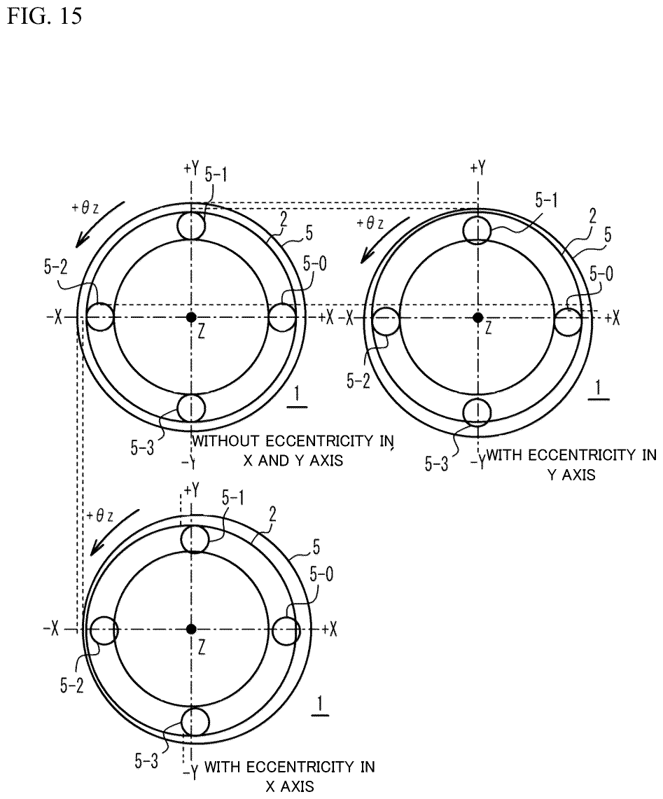

The detection axis of eccentricity is illustrated in FIG. 5A, and the detection axis of tilt is illustrated in FIG. 5B. FIG. 7 illustrates the rotary encoder 1 when viewed from the −Y direction to the +Y direction in FIG. 3A. As illustrated in FIG. 7, the detection heads 5-0 to 5-(n-1) are arranged on an installation surface F facing the rotor 2. The rotary encoder 1 illustrated in FIG. 4, FIG. 5A, FIG. 5B, FIG. 14, and FIG. 15 is equipped with four detection heads, the first detection head 5-0 to the fourth detection head 5-3.

The detection heads 5-0 to 5-(n-1) are arranged around the Z axis, which is the center of rotation of the rotor 2. The stator 5 is required to be mounted so that the detection heads 5-0 to 5-(n-1) are not eccentric with respect to the Z axis, which is the center of rotation of the rotor 2.

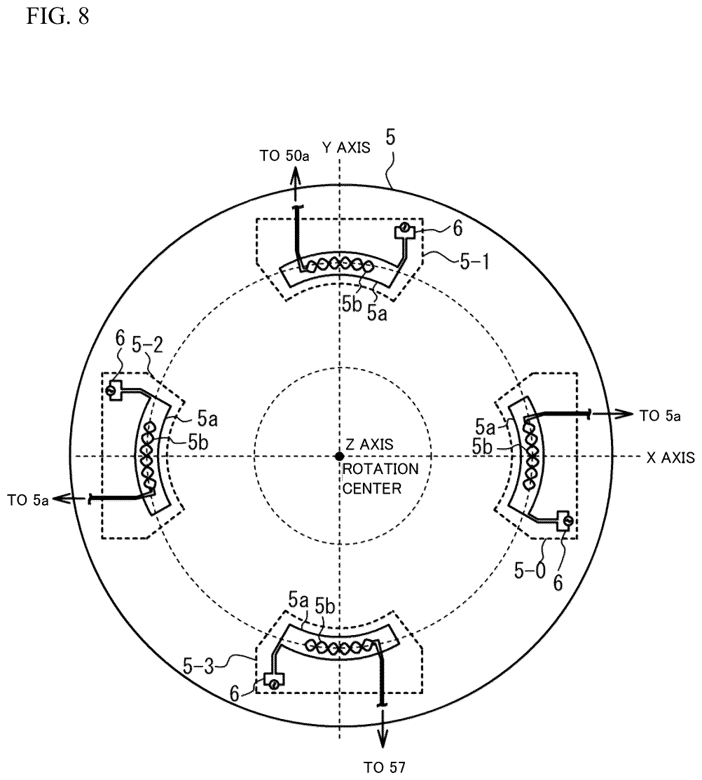

The detection heads 5-0 to 5-(n-1) are each provided with a transmission coil 5a and a reception coil 5b. FIG. 8 illustrates the first detection head 5-0 to the fourth detection head 5-3 arranged on the stator 5.

The transmission coil 5a forms a sector coil having a length in the circumferential direction. As illustrated in FIG. 8, the reception coil 5b forms a detection loop inside the transmission coil 5a, which is repeated in the circumferential direction with a fundamental period λ by a positive and negative sine wave waveform pattern of the fundamental period λ.

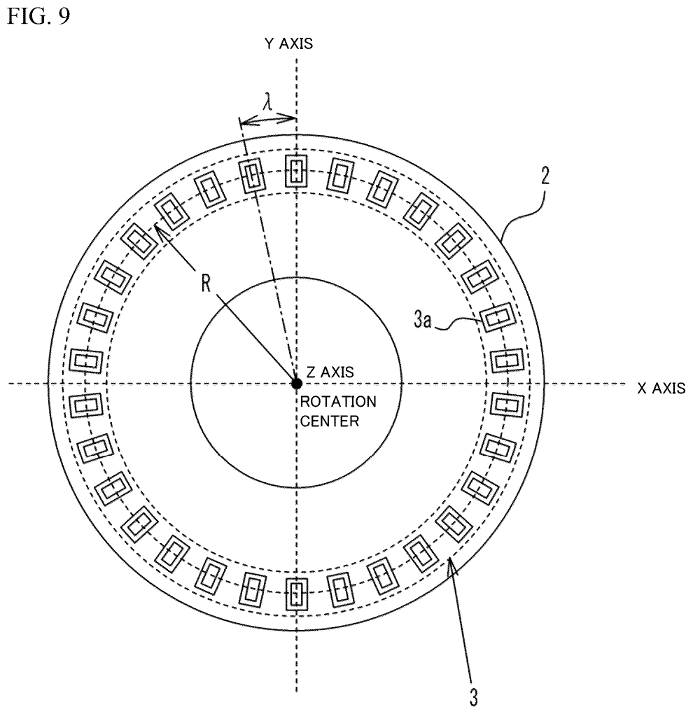

As illustrated in FIG. 9, the rotor 2 is a disk-shaped member, and is attached to the device rotation shaft member 101 (see FIG. 3 or the like) with its center aligned with the device rotation axis AX1 (Z-axis) of the device rotation shaft member 101. The rotor 2 has a scale pattern 3 including a plurality of patterns 3a arranged with the fundamental period λ along the circumferential direction of the rotor 2. The patterns 3a are closed loop coils. Each of the patterns 3a is electromagnetically coupled to the transmission coil 5a and also to the reception coil 5b.

The transmission circuit illustrated in FIG. 8 generates a single-phase AC drive signal and supplies the drive signal to the transmission coil 5a. In this case, a magnetic flux is generated in the transmission coil 5a. This generates an electromotive current in the patterns 3a. The patterns 3a generate a magnetic flux that changes in the circumferential direction with a predetermined spatial period by electromagnetically coupling with the magnetic flux generated by the transmission coil 5a. The magnetic flux generated by the transmission coil 5a generates an electromotive current in the reception coil 5b. The electromagnetic coupling between the coils changes according to the amount of displacement of the rotary encoder 1, and a sine wave signal with the same period as the fundamental period λ is obtained.

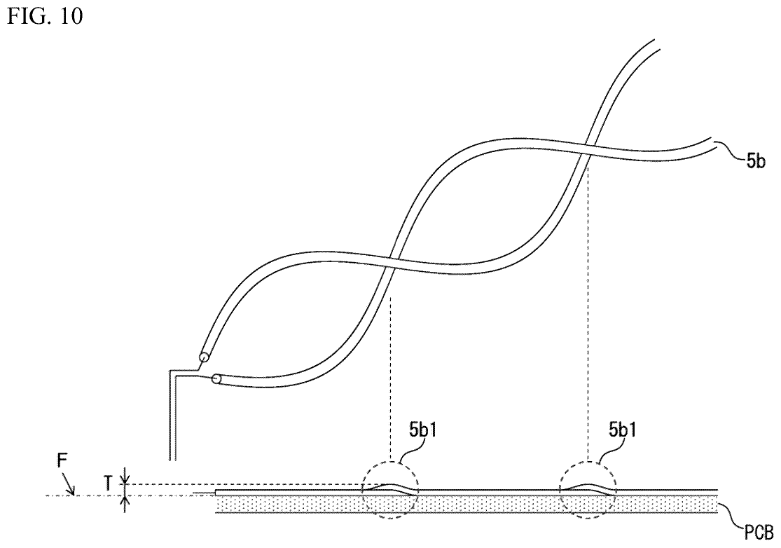

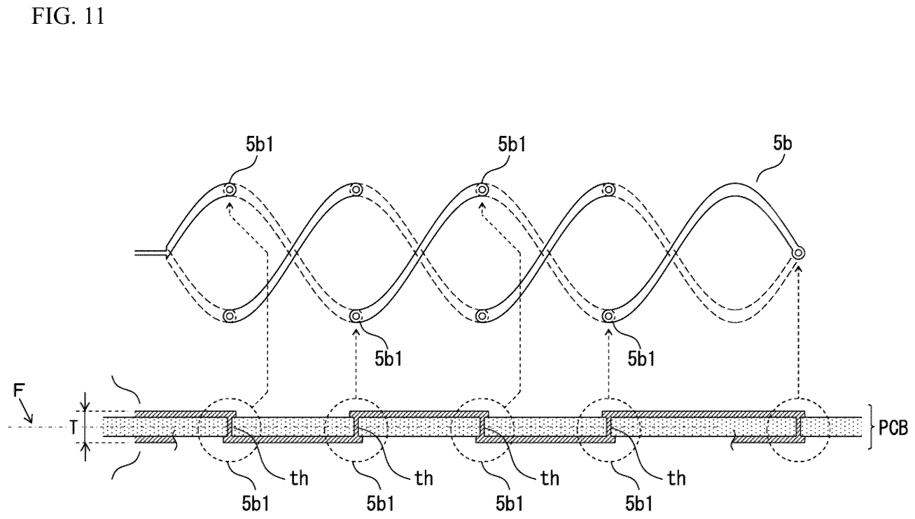

The installation surface F is, for example, a surface including the reception coil 5b formed on the surface of a flat member. The flat member is, for example, a board. Each of the reception coils 5b has a switching portion 5b 1 for switching between positive and negative sine wave patterns. Therefore, as illustrated in FIG. 10, the reception coil 5b is not only on the surface of the installation surface F, but also has a thickness of the reception coil thickness T. Also, as illustrated in FIG. 11, the reception coil 5b can be formed on a printed wiring board. In this case, the sine wave waveform patterns are arranged with an insulator between them, and a through hole th is arranged in the switching portion 5b 1 to electrically connect the two. In addition, since the sine wave waveform patterns are arranged at a distance of the reception coil thickness T, by setting the installation surface F to the midline of the reception coil thickness T, it is possible to perform highly accurate detection with a good signal balance. Furthermore, each of the reception coils 5b is connected to a signal processor 11a included in a calculator 11, and the signal acquired by each of the reception coils 5b is provided to the calculator 11. Each of the reception coil 5b and the signal processor 11a are connected by a wire, but may be connected wirelessly. In this embodiment, the information processing portion (CPU 52) and the calculator 11 are connected via a first connector 58 provided on the mounting support device 51 side and a second connector 59 provided on the rotary encoder 1 side.

In the rotary encoder 1 illustrated in FIG. 4 or the like, the first detection head 5-0 to the fourth detection head 5-3 are arranged at equal intervals around the circumference, but the intervals between the detection heads may not be equal but may be any interval. However, by arranging the detection heads 5-0 to 5-(n-1) at equal intervals, it becomes easier to calculate numerical values through calculations in the calculator 11, which will be described later. Here, the detection heads 5-0 to 5-(n-1) are arranged at equal intervals circumferentially, in other words, the detection heads are arranged circumferentially (on a circle with the Z axis as the central axis) around the Z axis, which is the center of rotation of the rotor 2.

In this embodiment, each of the detection heads is equipped with the transmission coil 5a, but for example, a single transmission coil may be provided, and the signal transmitted from this transmission coil to the rotor 2 may be received by each of the reception coils 5b.

The rotary encoder 1 of this embodiment is of the electromagnetic induction type, but it may be of a type using other detection principles, such as a capacitance type or a photoelectric type. In the case of a rotary encoder of another type, the transmission coil and the reception coil are respectively of a transmission section and a reception section according to the type adopted by the rotary encoder.

### Measurement Principle

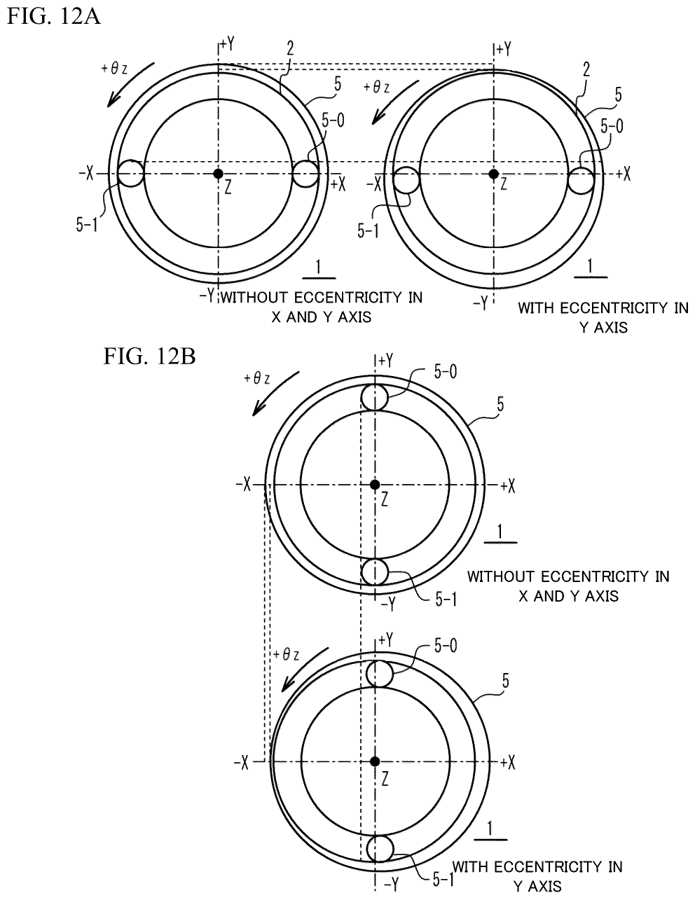

The mounting support device 51 uses the detection value detected by the detection head of the rotary encoder 1 to support in the relative position adjustment between the stator 5 and the rotor 2. Here, the measurement principle of the positional relationship between the rotor 2 and the stator 5 in the rotary encoder 1 will be described with reference to FIG. 12A to FIG. 18D.

Each figure depicts a rotary encoder with a different number and arrangement of detection heads. Strictly speaking, the detection heads and rotary encoders may differ between the figures, but for convenience of explanation, common reference numbers are used for the different detection heads and rotary encoders. In addition, elements illustrated in FIG. 4 and other figures may be simplified or omitted.

First, referring to FIG. 12A and FIG. 12B, a case in which the stator 5 is eccentric in the rotary encoder 1 equipped with two detection heads will be described. Note that the eccentricity between the stator 5 and the rotor 2 is relative, but in this embodiment, the state of the rotor 2 attached to the device rotation shaft member 101 is used as the reference, and the stator 5 is described as being eccentric.

Referring to FIG. 12A, the rotary encoder 1 has two detection heads on the stator 5, that is, the first detection head 5-0 and the second detection head 5-1. In the rotary encoder 1 illustrated in FIG. 12A, the first detection head 5-0 and the second detection head 5-1 are arranged at positions 180° apart on the X-axis. In other words, the first detection head 5-0 and the second detection head 5-1 are arranged on opposite sides of the X-axis across the Z-axis.

In the rotary encoder 1, assume that the stator 5 is eccentric on the-Y side as in the rotary encoder 1 illustrated on the right side of FIG. 12A. Then, the first detection head 5-0 shows a detection value as if the rotor 2 has rotated on the positive side (+θz) around the Z-axis. On the other hand, the second detection head 5-1 shows a detection value as if the rotor 2 has rotated on the negative side (−θz) around the Z-axis. When such a combination of detection values is obtained, it is found that the stator 5 has moved relatively to the −Y side (eccentricity). The amount of movement at this time is the absolute value of the detection value of the first detection head 5-0 and the detection value of the second detection head 5-1. If the ± of the detection values of the first detection head 5-0 and the second detection head 5-1 are switched, the stator 5 has moved relatively to the +Y side (eccentricity).

In the rotary encoder 1 illustrated in FIG. 12B, the first detection head 5-0 and the second detection head 5-1 are arranged at positions 180° apart on the Y axis. In other words, the first detection head 5-0 and the second detection head 5-1 are arranged on opposite sides of the Y axis across the Z axis.

In the rotary encoder 1, it is assumed that the stator 5 is eccentric to the +X side as in the rotary encoder 1 illustrated in the lower part of FIG. 12B. Then, the first detection head 5-0 shows a detection value as if the rotor 2 has rotated to the positive side (+θz) around the Z axis. On the other hand, the second detection head 5-1 shows a detection value as if the rotor 2 has rotated to the negative side (−θz) around the Z axis.

When such a combination of detection values is obtained, it is found that the stator 5 has moved relatively to the +X side (eccentricity). The amount of movement at this time is the absolute value of the detection value of the first detection head 5-0 and the detection value of the second detection head 5-1. Note that if the ± of the detection values of the first detection head 5-0 and the second detection head 5-1 are switched, the stator 5 has moved relatively to the-X side (eccentricity).

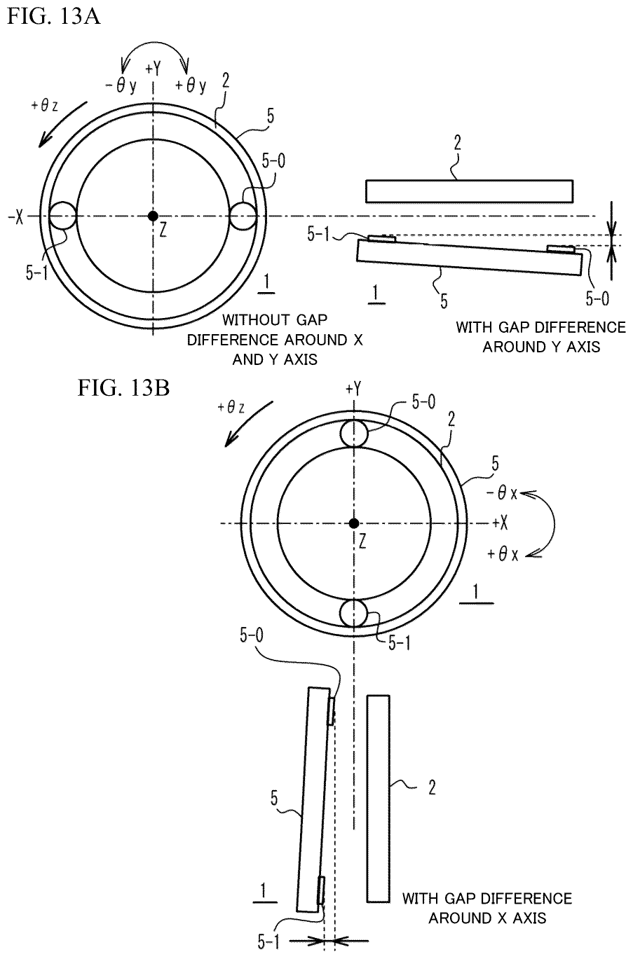

Next, referring to FIG. 13A and FIG. 13B, a case will be described in which the stator 5 is inclined with respect to the rotor 2 in the rotary encoder 1 equipped with two detection heads. Referring to FIG. 13A, the rotary encoder 1 includes the first detection head 5-0 and the second detection head 5-1, similar to the rotary encoder 1 illustrated in FIG. 12A. Here, the distance between the detection head and the rotor 2 correlates with the strength of the detection signal. Specifically, when the distance between the detection head and the rotor 2 is close (the gap variation is small), the strength of the detection signal becomes large (strong), and when the distance is far (far and the gap variation is large), the strength of the detection signal becomes small (weak). FIG. 14 is a diagram illustrating the correlation between the distance between the detection head provided on the stator 5 and the rotor 2, and the strength of the detection signal obtained from the reception coil. In FIG. 14, the horizontal axis indicates the distance [mm] between the two, and the vertical axis indicates the signal strength. The detection method of the rotary encoder 1 of this embodiment uses electromagnetic induction between the transmission coil and the reception coil, so as illustrated in FIG. 14, the signal strength decreases as the distance increases, and increases as the distance decreases. the distance between each detection head and the rotor 2 can be calculated when a map showing the relationship between the distance between the detection head and the rotor 2, and the strength of the detection signal as illustrated in FIG. 14 is stored in the mounting support device 51, and the strength of the detection signal obtained from each detection head is applied to the Y axis of the map illustrated in FIG. 14.

In the rotary encoder 1, it is assumed that the stator 5 is rotating in the +θy direction (clockwise direction in FIG. 13A) as in the rotary encoder 1 illustrated on the right side of FIG. 13A. Then, the distance between the first detection head 5-0 and the rotor 2 detected by the first detection head 5-0 is greater than the distance between the second detection head 5-1 and the rotor 2 detected by the second detection head 5-1. When such a combination of detection values is obtained, it is understood that the stator 5 is rotating relatively in the +θy direction. The amount of rotation at this time can be calculated from the difference between the detection value of the first detection head 5-0 and the detection value of the second detection head 5-1. Note that when the distance between the second detection head 5-1 and the rotor 2 is greater than the distance between the first detection head 5-0 and the rotor 2, the stator 5 is rotating relatively to the −θy side.

Referring to FIG. 13B, the rotary encoder 1 has the first detection head 5-0 and the second detection head 5-1, similar to the rotary encoder 1 illustrated in FIG. 12B. In this case, the distance between each detection head and the rotor 2 is calculated based on the strength of the detection signal.

In the rotary encoder 1, it is assumed that the stator 5 rotates in the +θx direction (clockwise direction in FIG. 13B) as in the rotary encoder 1 illustrated in the lower part of FIG. 13B. Then, the distance between the second detection head 5-1 and the rotor 2 detected by the second detection head 5-1 is greater than the distance between the first detection head 5-0 and the rotor 2 detected by the first detection head 5-0. When such a combination of detection values is obtained, it is understood that the stator 5 is rotating relatively in the +θx direction. The amount of rotation at this time can be calculated from the difference between the detection value of the first detection head 5-0 and the detection value of the second detection head 5-1. When the distance between the first detection head 5-0 and the rotor 2 is greater than the distance between the second detection head 5-1 and the rotor 2, the stator 5 rotates relatively toward the −θx side.

Next, with reference to FIG. 15, a case in which the stator 5 is eccentric in the rotary encoder 1 equipped with four detection heads will be described. With reference to FIG. 15, the rotary encoder 1 is equipped with four detection heads on the stator 5, namely, the first detection head 5-0, the second detection head 5-1, the third detection head 5-2, and the fourth detection head 5-3. In this rotary encoder 1, the first detection head 5-0 and the third detection head 5-2 are positioned 180° apart on the X-axis, and the second detection head 5-1 and the fourth detection head 5-3 are positioned 180° apart on the Y-axis. In other words, the first detection head 5-0 and the third detection head 5-2 are arranged on opposite sides of the X-axis across the Z-axis, and the second detection head 5-1 and the fourth detection head 5-3 are arranged on opposite sides of the Y-axis across the Z-axis. The first detection head 5-0 to the fourth detection head 5-3 are arranged at equal intervals, spaced 90° apart.

In the rotary encoder 1, it is assumed that the stator 5 is eccentric on the-Y side,

as in the rotary encoder 1 illustrated on the right side of FIG. 15. Then, the first detection head 5-0 shows a detection value as if the rotor 2 has rotated on the positive side (+θz) around the Z-axis. On the other hand, the third detection head 5-2 shows a detection value as if the rotor 2 has rotated on the negative side (−θz) around the Z-axis. And the detection value of the second detection head 5-1 and the detection value of the fourth detection head 5-3 both show values when there is no rotation around the Z-axis. When such a combination of detection values is obtained, it is understood that the stator 5 has moved relatively to the-Y side. The amount of movement at this time is the absolute value of the detection value of the first detection head 5-0 and the detection value of the third detection head 5-2. If the ± of the detection value of the first detection head 5-0 and the detection value of the third detection head 5-2 are switched, the stator 5 has moved relatively to the +Y side.

In the rotary encoder 1 illustrated in FIG. 15, it is assumed that the stator 5 is eccentric on the +X side as illustrated in the lower part of FIG. 15. Then, the second detection head 5-1 shows a detection value as if the rotor 2 has rotated on the positive side (+θz) around the Z axis. On the other hand, the fourth detection head 5-3 shows a detection value as if the rotor 2 has rotated on the negative side (−θz) around the Z axis. The detection value of the first detection head 5-0 and the detection value of the third detection head 5-2 both show values when there is no rotation around the Z axis. When such a combination of detection values is obtained, it is understood that the stator 5 has moved relatively to the +X side. The amount of movement at this time is the absolute value of the detection value of the second detection head 5-1 and the detection value of the fourth detection head 5-3. Note that if the ± of the detection value of the second detection head 5-1 and the detection value of the fourth detection head 5-3 are switched, the stator 5 has moved relatively to the-X side.

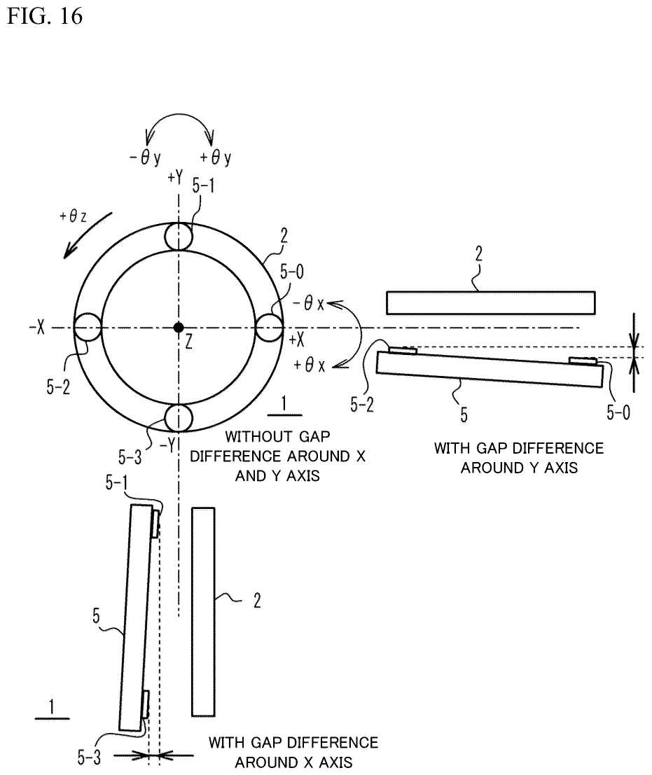

Next, referring to FIG. 16, a case will be described in which the stator 5 is inclined with respect to the rotor 2 in the rotary encoder 1 equipped with four detection heads. Referring to FIG. 16, the rotary encoder 1 is equipped with the first detection head 5-0 to the fourth detection head 5-3, similar to the rotary encoder 1 illustrated in FIG. 15. The distance between each detection head and the rotor 2 is calculated based on the strength of the detection signal of each detection head.

In the rotary encoder 1, it is assumed that the stator 5 rotates in the +Oy direction (clockwise direction in FIG. 16) as in the rotary encoder 1 illustrated on the right side of FIG. 16. Then, the distance between the first detection head 5-0 and the rotor 2 detected by the first detection head 5-0 is greater than the distance between the third detection head 5-2 and the rotor 2 detected by the third detection head 5-2. The detection value of the second detection head 5-1 and the detection value of the fourth detection head 5-3 are the same. When such a combination of detection values is obtained, it is found that the stator 5 is rotating relatively in the +0y direction. The amount of rotation at this time can be calculated from the difference between the detection value of the first detection head 5-0 and the detection value of the third detection head 5-2. If the distance between the third detection head 5-2 and the rotor 2 is greater than the distance between the first detection head 5-0 and the rotor 2, the stator 5 is rotating relatively toward the −θy side.

In the rotary encoder 1, it is assumed that the stator 5 is rotating in the +θx direction (clockwise direction in FIG. 16) as in the rotary encoder 1 illustrated in the lower part of FIG. 16. Then, the distance between the fourth detection head 5-3 and the rotor 2 detected by the fourth detection head 5-3 is greater than the distance between the second detection head 5-1 and the rotor 2 detected by the second detection head 5-1. Then, the detection value of the first detection head 5-0 and the detection value of the third detection head 5-2 are the same value. When such a combination of detection values is obtained, it is found that the stator 5 is rotating relatively in the +θx direction.

The amount of rotation at this time can be calculated from the difference between the detection value of the second detection head 5-1 and the detection value of the fourth detection head 5-3. Note that when the distance between the second detection head 5-1 and the rotor 2 is greater than the distance between the fourth detection head 5-3 and the rotor 2, the stator 5 is rotating relatively toward the-Ox side.

In FIG. 12A to FIG. 16, the cases where there are two and four detection heads are described, but if there are two or more detection heads, the relative positional relationship between the stator 5 and the rotor 2 can be measured in a similar manner.

The rotation around the Z axis can be detected from the detection values of each detection head, as in the case of a conventional rotary encoder. The rotation angle (amount of rotation) around the Z axis can be, for example, the average value of the detection values (angle output) of each detection head. Also, the average value of the distance between each detection head and the rotor 2 calculated based on the detection of each detection head can be the relative movement amount along the Z axis direction, that is, the gap. The stator 5 and the rotor 2 are required to be parallel, and the gap between them is also required to be appropriate. The distance between the stator 5 and the rotor 2 can be grasped based on the strength of the detection signal of the detection head. Also, the gap between them can be adjusted based on the strength of the detection signal.

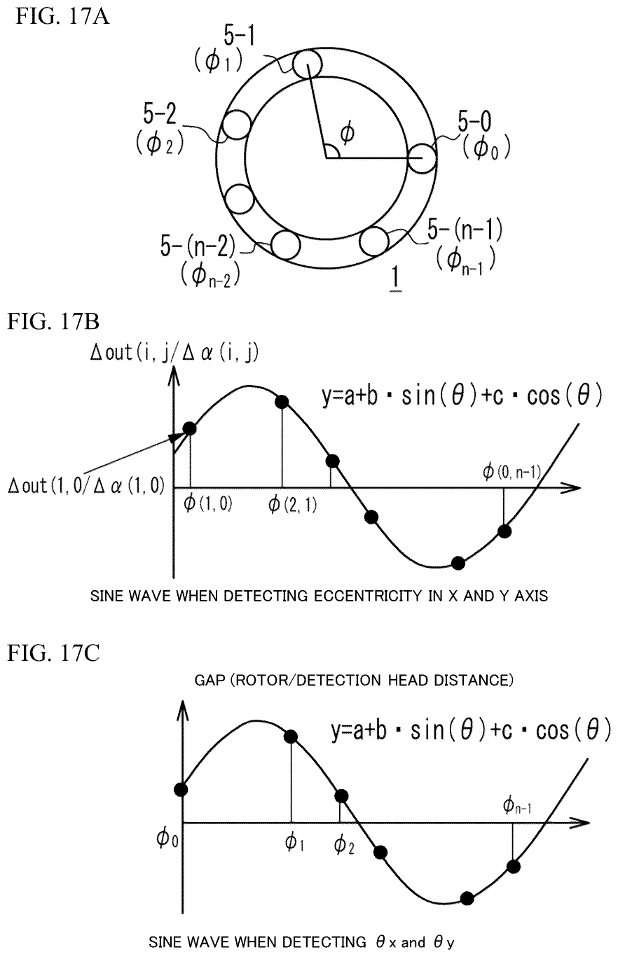

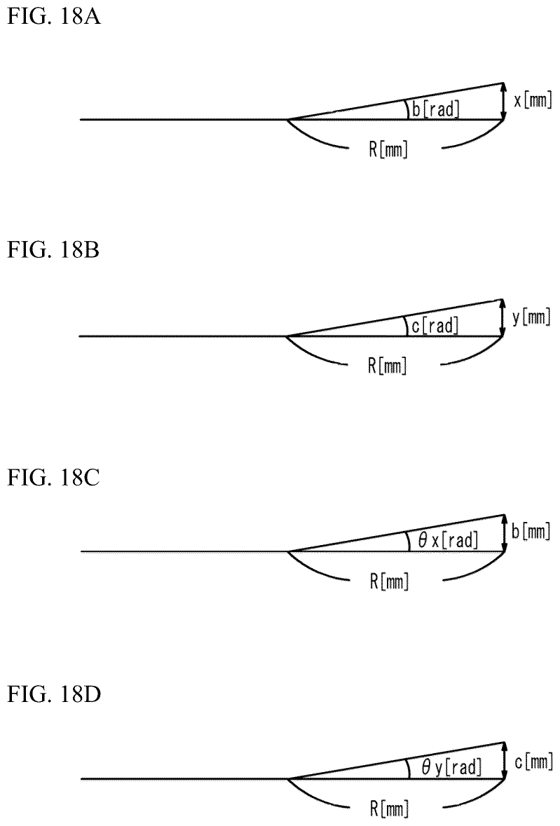

Next, the calculation of the displacement amount and the numerical value of the gap will be explained with reference to FIG. 17A to FIG. 18D. The calculation of the numerical value is performed by the calculator 11 illustrated in FIG. 1.

In the following explanation, the rotary encoder 1 illustrated in FIG. 17A will be referred to. The rotary encoder 1 illustrated in FIG. 17A is equipped with n detection heads, from the first detection head 5-0 to the n-th detection head 5-(n-1). In the figure, “φ” indicates the installation position of each detection head. Specifically, it indicates the clockwise angle with the installation position φ0 of the first detection head 5-0 as the reference position.

### When the Stator is Eccentric Relative to the Rotor

First, referring to FIG. 17B, a case will be described in which the stator 5 equipped with the detection heads is eccentric relative to the rotor 2. The relative movement amount X (eccentricity amount) along the X-axis direction and the relative movement amount Y (eccentricity amount) along the Y-axis direction can be obtained from the amplitude and phase of the eccentricity error. The angle output outk of the k-th (k=0 to n-1) detection head out of the n detection heads is expressed as the sum of the ideal angle output, that is, the angle output obtained when there is no eccentricity, and the eccentricity error (see formula (1)).

$${Out}_{k} = ideal angle output ( k ) + eccentricity error ( k ) \qquad [ Formula 1 ]$$

Now consider the difference in the angular output between the two detection heads i and j (see formula (2)).

$${Out}_{i} - {Out}_{j} = ideal angle output ( i ) - ideal angle output ( j ) + eccentricity error ( i ) - eccentricity error ( j ) \qquad [ Formula 2 ]$$

The ideal angle (i)-ideal angle (j) is equal to the difference in the placement of the two detection heads, φi-φj, so the eccentricity error can be extracted by defining Δout using the following formula (3).

$$ΔOut ( i , j ) = {Out}_{i} - {Out}_{j} - ( {Φ}_{i} - {Φ}_{j} ) = eccentricity error ( i ) - eccentricity error ( j ) \qquad [ Formula 3 ]$$

If the amplitude of the eccentricity error when φ=0 is taken as the reference point, and the phase is β, these can be expressed as in the following formula (4).

$$Exxentricity error ( i ) = α sin ( {Φ}_{i} + β ) Eccentricity error ( j ) = α sin ( {Φ}_{j} + β ) \qquad [ Formula 4 ]$$

Therefore, Δout (i, j) is expressed as in the following formula (5).

$$Δ Out ( i , j ) = α sin ( {Φ}_{i} + β ) - α sin ( {Φ}_{j} + β ) \qquad [ Formula 5 ]$$

By transforming the formula (5), Δout (i, j) can be expressed as in the following formula (6).

$$Δ Out ( i , j ) = α \cdot Δα ( i , j ) \cdot sin ( Δ Φ ( i , j ) + β ) \qquad [ Formula 6 ]$$

Here, Δα(i,j) and Δφ(i,j) are constants that depend on the arrangement of the two detection heads. In other words, Δout (i,j) is a sine wave whose amplitude is multiplied by Δα(i,j) and whose phase is shifted by φi,j compared to the eccentricity error when φ=0 is used as the reference. Therefore, if Out(i,j) divided by Δα(i,j) is plotted on the vertical axis and Δφ(i,j) on the horizontal axis, a plot like that illustrated in FIG. 17B is obtained, and the amplitude and phase of the eccentricity error can be found by fitting this to a sine wave.

Here, an example of calculating the coefficients a, b, and c by fitting to y=a+bsin(θ)+ccos(θ) which shows the sine wave illustrated in FIG. 17B will be described. Here, to simplify the calculation, it is assumed that the first detection head 5-0 to the n-th detection head 5-(n-1) are arranged at equal intervals.

The coefficients a, b, and c can be calculated by applying the least squares method using the following formula (7). In the formula (7), parts A and B are parts determined by the arrangement of the detection heads, and a part C is Δout(i,j)/Δα(i,j) calculated from the difference in the angular output of each detection head and the arrangement of the detection heads.

$$( \begin{matrix}\text{?} \\ \text{?} \\ \text{?}\end{matrix} ) = {\underbrace{( \begin{matrix}\text{?} & \text{?} & \text{?} \\ \text{?} & \text{?} & \text{?} \\ \text{?} & \text{?} & \text{?}\end{matrix} )}}_{A} \text{?} {\underbrace{( \begin{matrix}\text{?} & \text{?} & \text{?} \\ \text{?} & \text{?} & \text{?} \\ \text{?} & \text{?} & \text{?}\end{matrix} )}}_{B} {\underbrace{( \begin{matrix}\text{?} & \text{?} & \text{?} \\ \text{?} & \text{?} & \text{?} \\ & \text{?} & \\ \text{?} & \text{?} & \text{?}\end{matrix} )}}_{C} \qquad [ Formula 7 ]$$

$$\text{?} \text{indicates text missing or illegible when filed}$$

Here, by arranging the detection heads at equal intervals, the part A becomes a diagonal matrix, making the calculation easier.

The formula 7 is a general formula for n detection heads. In the case of four detection heads, the coefficients a, b, and c can be calculated using the following formula (8). In the case of eight detection heads, the coefficients a, b, and c can be calculated using the following formula (9).

$$( \begin{matrix}a \\ b \\ c\end{matrix} ) = {( \begin{matrix}4 & 0 & 0 \\ 0 & 2 & 0 \\ 0 & 0 & 2\end{matrix} )}^{- 1} ( \begin{matrix}1 & 1 & 1 & 1 \\ - 1 / \sqrt{2} & - 1 / \sqrt{2} & - 1 / \sqrt{2} & 1 / \sqrt{2} \\ - 1 / \sqrt{2} & 1 / \sqrt{2} & - 1 / \sqrt{2} & - 1 / \sqrt{2}\end{matrix} ) \cdot ( \begin{matrix}Δ out ( 1 , 0 ) / α ( 1 , 0 ) \\ Δ out ( 2 , 1 ) / α ( 2 , 1 ) \\ Δ out ( 3 , 2 ) / α ( 3 , 2 ) \\ Δ out ( 0 , 3 ) / α ( 0 , 3 )\end{matrix} ) \qquad [ Formula 8 ]$$

$$( \begin{matrix}a \\ b \\ c\end{matrix} ) = {( \begin{matrix}8 & 0 & 0 \\ 0 & 4 & 0 \\ 0 & 0 & 4\end{matrix} )}^{- 1} ( \begin{matrix}1 & 1 & 1 & 1 & 1 & 1 & 1 & 1 \\ - {t}_{1} & - {t}_{1} & - {t}_{2} & {t}_{2} & {t}_{1} & {t}_{1} & {t}_{2} & - {t}_{2} \\ - {t}_{2} & {t}_{2} & {t}_{1} & {t}_{1} & {t}_{2} & - {t}_{2} & - {t}_{1} & - {t}_{1}\end{matrix} ) \cdot ( \begin{matrix}Δ out ( 1 , 0 ) / α ( 1 , 0 ) \\ Δ out ( 2 , 1 ) / α ( 2 , 1 ) \\ ⋮ \\ Δ out ( 0 , 7 ) / α ( 0 , 7 )\end{matrix} ) \\ {t}_{1} = cos ( 22.5 ° ) , {t}_{2} = sin ( 22.5 ° ) \qquad [ Formula 9 ]$$

By performing the above calculations, the coefficients a, b, and c can be calculated, and the equation y=a+b sin(θ)+c cos(θ), which represents a sine wave, can be specified. Then, the coefficient b in this equation can be used to calculate the relative movement amount X (eccentricity) along the X-axis, and the coefficient c can be used to calculate the relative movement amount Y (eccentricity) along the Y-axis.

The relative movement amount X [mm] has a relationship between the coefficient b [rad] and R [mm] as illustrated in FIG. 18A. Here, R [mm] is the radius of the scale pattern 3.

Therefore, the relative movement amount X [mm] is calculated by the following formula 10.

$$X = R \times tan ( b ) \approx R \times b ( R >> X ) \qquad [ Formula 10 ]$$

Similarly, the relative movement amount Y [mm] has a relationship between the coefficient c [rad] and R [mm] as illustrated in FIG. 18B. Here, R [mm] is the radius of the scale pattern 3.

Therefore, the relative movement amount Y [mm] is calculated by the following formula 11.

$$Y = R \times tan ( c ) \approx R \times c ( R >> Y ) \qquad [ Formula 11 ]$$

In this way, the relative movement amount X [mm] and the relative movement amount Y [mm] can be calculated.

### When the Stator Rotates Relative to the Rotor

Next, referring to FIG. 17C, a case where the stator 5 equipped with the detection head group rotates relative to the rotor 2 will be described. Specifically, a case will be described in which the stator 5 rotates around the X-axis and also around the Y-axis relative to the rotor 2. The amount of relative rotation θx (amount of tilt) around the X-axis and the amount of relative rotation θy (amount of tilt) around the Y-axis can be found from the amplitude and phase of the gap fluctuation (the distance between each detection head and the rotor 2).

When detecting the relative rotation amount ex around the X-axis and the relative rotation amount θy around the Y-axis, the vertical axis is the gap in the sine wave illustrated in FIG. 17C. The gaps at each of the circumferentially arranged detection heads, from the first detection head 5-0 to the n-th detection head 5-(n-1), are plotted and fitted to determine the coefficients a, b, and c of the sine wave (a+bsin(θ)+ccos(θ)). The amplitude of this fitted sine wave is the amplitude of the gap fluctuation. In other words, √(b2+c2) is the amplitude of the gap fluctuation.

The coefficients a, b, and c can be calculated by applying the least squares method using the following formula (12). In the formula (12), the parts A and B are parts determined by the arrangement of the detection heads, and the part C is a matrix of the gap values at each detection head.

$$[ Formula 12 ]$$

$$( \begin{matrix}a \\ b \\ c\end{matrix} ) = {( \begin{matrix}n & {\sum }_{k = 0}^{n - 1} sin {ϕ}_{k} & {\sum }_{k = 0}^{n - 1} cos {ϕ}_{k} \\ {\sum }_{k = 0}^{n - 1} sin {ϕ}_{k} & {\sum }_{k = 0}^{n - 1} {sin}^{2} {ϕ}_{k} & {\sum }_{k = 0}^{n - 1} sin {ϕ}_{k} cos {ϕ}_{k} \\ {\sum }_{k = 0}^{n - 1} cos {ϕ}_{k} & {\sum }_{k = 0}^{n - 1} sin {ϕ}_{k} cos {ϕ}_{k} & {\sum }_{k = 0}^{n - 1} {cos}^{2} {ϕ}_{k}\end{matrix} )}^{- 1} \cdot ( \begin{matrix}1 & 1 & … & 1 \\ sin {ϕ}_{0} & sin {ϕ}_{1} & … & sin {ϕ}_{n - 1} \\ cos {ϕ}_{0} & cos {ϕ}_{0} & … & cos {ϕ}_{n - 1}\end{matrix} ) \cdot ( \begin{matrix}{Z}_{0} \\ {Z}_{1} \\ ⋮ \\ {Z}_{n - 1}\end{matrix} ) \\ A : 3 \times 3 B : 3 \times n C : n \times 1$$

Here, by arranging the detection heads at equal intervals, the A part becomes a diagonal matrix, making the calculation easier.

The formula (12) is a general equation for n detection heads, but when there are four detection heads, the coefficients a, b, and c can be found using the following formula (13). When there are eight detection heads, the coefficients a, b, and c can be found using the following formula (14).

$$( \begin{matrix}a \\ b \\ c\end{matrix} ) = {( \begin{matrix}4 & 0 & 0 \\ 0 & 2 & 0 \\ 0 & 0 & 2\end{matrix} )}^{- 1} \cdot ( \begin{matrix}1 & 1 & 1 & 1 \\ 0 & 1 & 0 & - 1 \\ 1 & 0 & - 1 & 1\end{matrix} ) \cdot ( \begin{matrix}{Z}_{0} \\ {Z}_{1} \\ {Z}_{2} \\ {Z}_{3}\end{matrix} ) \qquad [ Formula 13 ]$$

$$[ Formula 14 ]$$

$$( \begin{matrix}a \\ b \\ c\end{matrix} ) = {( \begin{matrix}8 & 0 & 0 \\ 0 & 4 & 0 \\ 0 & 0 & 4\end{matrix} )}^{- 1} \cdot ( \begin{matrix}1 & 1 & 1 & 1 & 1 & 1 & 1 & 1 \\ 0 & 1 / \sqrt{2} & 1 & 1 / \sqrt{2} & 0 & - 1 / \sqrt{2} & - 1 & - 1 / \sqrt{2} \\ 1 & 1 / \sqrt{2} & 0 & - 1 / \sqrt{2} & - 1 & - 1 / \sqrt{2} & 0 & 1 / \sqrt{2}\end{matrix} ) \cdot ( \begin{matrix}{Z}_{0} \\ {Z}_{1} \\ {Z}_{2} \\ {Z}_{3} \\ {Z}_{4} \\ {Z}_{5} \\ {Z}_{6} \\ {Z}_{7}\end{matrix} )$$

By performing the above calculations, the coefficients a, b, and c can be found, and the equation y=a+bsin(θ)+ccos(θ), which represents a sine wave, can be specified. Then, the coefficient b in this formula can be used to find the relative rotation amount θx (tilt amount) around the X axis, and the coefficient c can be used to find the relative rotation amount θy (tilt amount) around the Y axis.

The amount of relative rotation θx [rad] has a relationship between the coefficient b [mm] and R [mm] as illustrated in FIG. 18 C. Here, R [mm] is the radius of the scale pattern 3.

Therefore, the relative rotation amount θx [rad] is calculated by the following formula 15.

$$θ x = tan - 1 ( b / R ) \approx b / R ( R >> b ) \qquad [ Formula 15 ]$$

Similarly, the relative rotation amount θy [rad] has a relationship between the coefficient c [mm] and R [mm] as illustrated in FIG. 18D. Here, R [mm] is the radius of the scale pattern 3.

Therefore, the relative rotation amount θy [rad] is calculated by the following formula 16.

$$θ y = tan - 1 ( c / R ) \approx c / R ( R >> c ) \qquad [ Formula 16 ]$$

In this way, the relative rotation amount θx [rad] and the relative rotation amount θy [rad] can be calculated.

The rotary encoder 1 can detect the amount of eccentricity when the rotor 2 is in an eccentric position, and the amount of tilt when the rotor 2 is in an inclined position. In the above explanation, these are explained separately. That is, detection of the amount of eccentricity in a posture situation in which the stator 5 is eccentric is described with reference to FIG. 12A, FIG. 12B and FIG. 15, and detection of the amount of tilt in a posture situation in which the stator 5 is tilted is described with reference to FIG. 13A,

FIG. 13B and FIG. 16. However, the rotary encoder 1 can simultaneously detect the amount of eccentricity and the amount of tilt even in a posture situation in which the rotor 2 is eccentric and tilted.

### Mounting Support Device

Returning to FIG. 1, the mounting support device 51 will be described. The mounting support device 51 is composed of a so-called computer equipped with a CPU (Central Processing Unit) 52, a displayer 53, an inputter 54, a program storage 55, and a RAM (Random Access Memory) 56. The CPU 52 is a central processing unit and functions as an information processing unit. The CPU 52 includes one or more cores.

The displayer 53 displays various information for mounting support. The inputter 54 is used for selecting menus for mounting support and for various inputs associated with the progress of work. The program storage 55 is composed of, for example, a ROM (Read Only Memory), a solid state drive (SSD) such as a flash memory, or a hard disk driven by a hard disk drive (HDD). The program stored in the program storage 55 is a mounting support program that supports in adjusting the relative positions of the rotor 2 and the stator 5.

The RAM 56 is a volatile memory that temporarily stores the programs executed by the CPU 52, data processed by the CPU 52, and the like. The first connector 58 is connected to the CPU 52. The first connector 58 is connected to the second connector 59 provided on the rotary encoder 1 side. The second connector 59 is connected to the calculator 11 provided in the rotary encoder 1. By connecting the first connector 58 and the second connector 59, various numerical values of the rotary encoder 1 calculated by the calculator 11 are provided to the CPU 52. The CPU 52 uses the numerical values provided by the calculator 11 to perform various calculations required for mounting support of the rotary encoder 1. The second connector 59 can be replaced with a third connector 62 extending from a device controller 60 to which the rotary encoder 1 is attached. When the device equipped with the rotary encoder 1 is operated, the second connector 59 is replaced with the third connector 62. This allows the device controller 60 to execute various controls of the device using the signals received by each of the reception coils 5b. The device controller 60 is electrically connected to a driver 61 that rotates the device rotation shaft member 101 to which the rotor 2 is attached, and controls the rotation of the device rotation shaft member 101. By making it possible to replace the connection destination of the second connector 59 from the third connector 62 to the first connector 58, the rotary encoder 1 can be mounted and its position adjusted at the site where the device is installed.

### Position Adjustment Mechanism

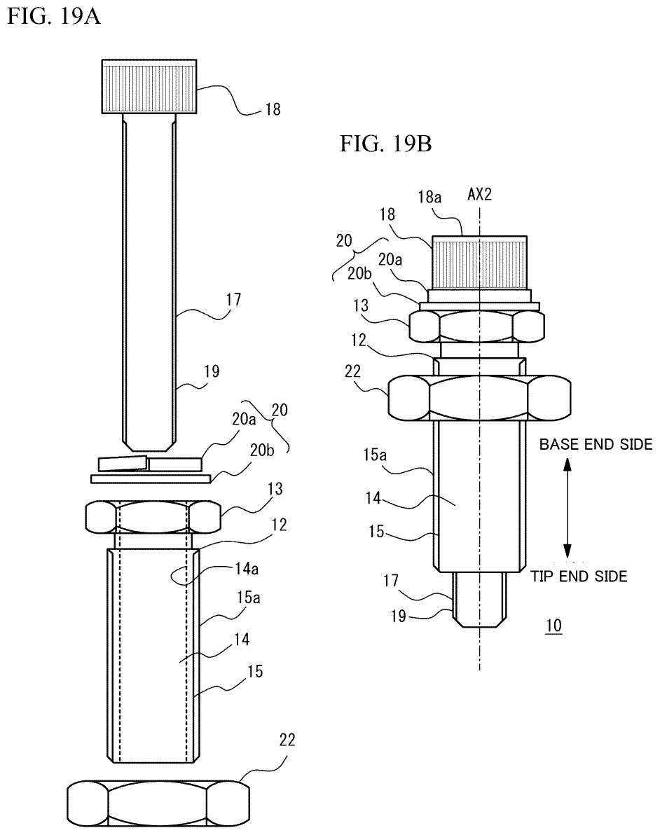

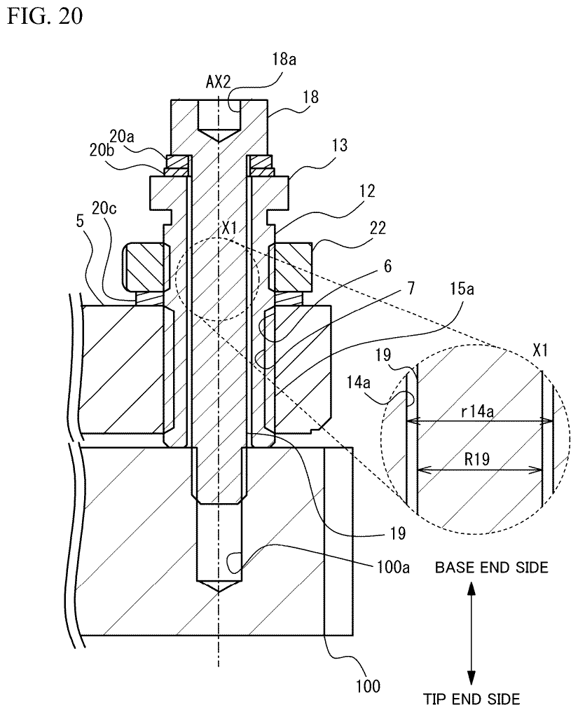

Next, the configuration of the position adjustment mechanism 10 will be described with reference to FIG. 19A to FIG. 20. The position adjustment mechanism 10 allows the position of the stator 5 to be adjusted, and allows the stator 5 to be installed parallel to the rotor 2 and at any distance without being eccentric relative to the rotor 2. In this embodiment, the mounting support device 51 grasps the eccentric state of the stator 5 and the state of the gap with respect to the rotor 2. Then, the position adjustment of the stator 5 is performed based on the instruction of the mounting support device 51. At this time, the position adjustment mechanism 10 is used, so that the position adjustment of the stator 5 can be easily performed. In other words, the height of the stator 5 can be adjusted by using the position adjustment mechanism 10 that supports the stator 5, and the inclination can be changed by adjusting the position adjustment mechanism at each of the three positions to a different height. Furthermore, the position adjustment mechanism 10 can easily perform the eccentric adjustment of the stator 5 with respect to the rotation axis AX1. The position adjustment mechanism 10 includes a hollow bolt 12, a fixing screw 17, and a nut 22. The position adjustment mechanism 10 also includes a pressurizing mechanism 20.

The hollow bolt 12 includes a head 13 that has a hexagonal shape in a plan view on the base end side. However, the shape of the head 13 is not limited to the hexagonal shape, and various shapes that are known in the art can be adopted. A hollow cylindrical portion 14, which corresponds to the shaft portion of the hollow bolt 12 and extends toward the tip side, is connected to the head 13. The hollow cylindrical portion 14 has an inner peripheral surface 14a with an inner diameter r14a. The inner diameter r14a is the diameter of the inner peripheral surface 14a of the hollow cylindrical portion 14. An outer peripheral screw portion 15a is formed on an outer peripheral surface 15 of the hollow cylindrical portion 14. In other words, the hollow bolt 12 is a male screw. The outer peripheral screw portion 15a is screwed with an inner peripheral screw portion (female screw portion) 7 provided in a mounting hole 6 of the stator 5. The stator 5 can move up and down along the Z-axis direction according to the rotation direction of the hollow bolt 12 by rotating the hollow bolt 12, and the distance between the stator 5 and the base part 100, that is, the position in the height direction (Z-axis direction) is adjusted. As a result, the distance between the rotor 2 and the stator 5 is adjusted.

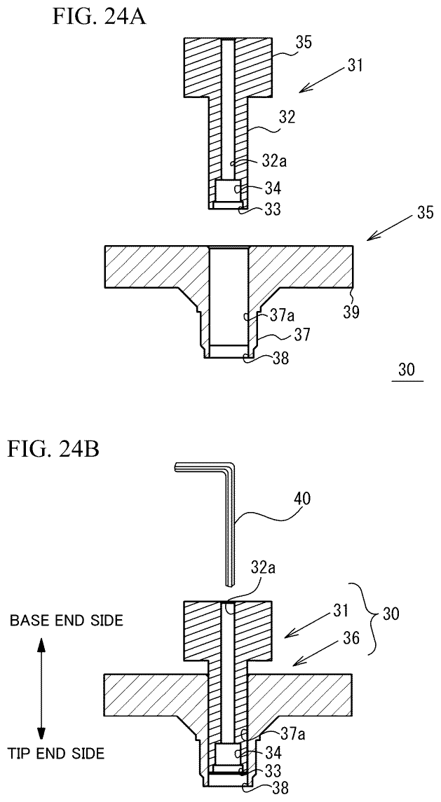

The fixing screw 17 has a head 18 provided on the base end side. The head 18 has a tool hole 18a. In this embodiment, the tool hole 18a is a hexagonal hole and can be rotated using a hexagonal wrench (see FIG. 24B and the like). The tool hole 18a may have other shapes and may have various shapes that are well known in the art. The tool hole 18a may have, for example, a + (plus) or − (minus) shape. A screw portion 19 is connected to the head 18 and is rod-shaped extending toward the tip side and has an outer diameter R19. The screw portion 19 is screwed into the screw hole 100a provided in the base part 100. The fixing screw 17 can also fix the stator 5 to the base part 100.

The outer diameter R19 of the screw portion 19 is smaller than the inner diameter r14a of the inner peripheral surface 14a of the hollow cylindrical portion 14. By making the outer diameter R19<the inner diameter r14a, a gap is formed between the inner peripheral surface 14a and the screw portion 19. As a result, when the fixing screw 17 is loosened, the hollow bolt 12 can move in the X direction or the Y direction relative to the screw portion 19. Since the stator 5 is attached to the hollow bolt 12, the stator 5 can move in the X direction or the Y direction relative to the screw portion 19. In other words, the stator 5 can move in the X direction or the Y direction relative to the central axis AX2 of the screw hole 100a into which the screw portion 19 is screwed, and the eccentricity of the stator 5 relative to the rotor 2 can be eliminated. In this way, the position of the stator 5 can be adjusted within a plane (X-Y plane) parallel to the base part 100.

In order for the hollow bolt 12 to be rotatable, it is necessary to loosen the fixing screw 17 and the nut 22. The fixing screw 17 and the nut 22 are loosened and the hollow bolt 12 rotates, allowing the stator 5 to move up and down as described above.

The nut 22 is screwed onto the outer peripheral screw portion 15a of the hollow bolt 12. The nut 22 is disposed on the Z-direction upper side of the stator 5 that is screwed onto the outer peripheral screw portion 15a of the hollow bolt 12. In other words, the nut 22 is disposed between the stator 5 and the head 13 of the hollow bolt 12. The dimensions of the nut 22 in this embodiment, specifically the opposite side dimension, which is the distance between the opposing sides (faces), is larger than the opposite side dimension of the head 13 of the hollow bolt 12. The outer shape of the nut 22 in this embodiment is hexagonal, but the outer shape of the nut 22 is not limited to a hexagon, and various shapes known in the art can be adopted. In addition, in this specification, the above-mentioned opposite side dimensions are compared when comparing the sizes of nuts and bolts, but the diagonal dimension, which is the distance between opposing corners, may be used instead of the opposite side dimension. In short, a dimension that allows the size of nuts and bolts to be compared can be adopted. The stator 5 has the inner peripheral screw portion 7, and the stator 5 itself has a structure similar to that of a nut. Therefore, the nut 22 can obtain a so-called double nut effect together with the stator 5. Therefore, when the nut 22 is tightened and fastened to the stator 5, it is possible to stop the rotation of the hollow bolt 12 and maintain the position of the stator 5 in the Z-axis direction.

In the position adjustment mechanism 10, the nut 22 is located on the tip side of the head 13 of the hollow bolt 12. A second fitting portion 38 fits into the nut 22 as described in detail later. A first fitting portion 33 fits into the head 13 as described in detail later. A first columnar portion 32 provided with the first fitting portion 33 and a second columnar portion 37 provided with the second fitting portion 38 are arranged coaxially, but the first columnar portion 32 is arranged inside the second columnar portion 37. Therefore, by making the opposite side dimension of the nut 22 larger than the opposite side dimension of the head 13 of the hollow bolt 12, it is possible to make it easier to fit the nut 22 into the second fitting portion 38 and fit the head 13 into the first fitting portion 33. However, it is sufficient that the opposite side dimension of the nut 22 is equal to or larger than the opposite side dimension of the head 13 of the hollow bolt 12.

In other words, the opposite side dimension of the nut 22 may be the same value as the opposite side dimension of the head 13 of the hollow bolt 12.

Here, the action of the fixing screw 17 and the nut 22 on the hollow bolt 12 will be summarized and explained. First, when both the fixing screw 17 and the nut 22 are loosened, the hollow bolt 12 can rotate. Furthermore, when the fixing screw 17 is loosened, the hollow bolt 12 is permitted to move in the X and Y directions. Next, when the fixing screw 17 is loosened and the nut 22 is tightened to be in a fastened state, the hollow bolt 12 is permitted to move in the X and Y directions, and the rotation of the hollow bolt 12 is stopped. If the fixing screw 17 is turned without fixing the rotation of the hollow bolt 12 with the nut 22, the fixing screw 17 and the hollow bolt 12 will rotate together, and the stator 5 may be displaced in all directions of X, Y, and Z. In this case, it is expected that fine position adjustment of the stator 5, for example, of 0.1 mm or less, will be difficult. By appropriately tightening and loosening the fixing screw 17 and the nut 22, the stator 5 can be maintained in a desired state.

In this embodiment, a first washer 20a and a second washer 20b are disposed between the head 18 of the fixing screw 17 and the head 13 of the hollow bolt 12. The first washer 20a is a spring washer, and the second washer 20b is a flat washer. The first washer 20a and the second washer 20b are included in the pressurizing mechanism 20. The pressurizing mechanism 20 has an elastic force that biases the hollow bolt 12 toward the base part 100. The first washer 20a is an example of a spring member, and exerts an elastic force (biasing force) that biases the hollow bolt 12 toward the base part 100. The second washer 20b suppresses slippage between the fixing screw 17 and the hollow bolt 12, and distributes the biasing force to stabilize the positional relationship between the two. The pressurizing mechanism 20 may include other elastic members, such as a compression spring, instead of or in addition to the first washer 20a. The pressurizing mechanism 20 biases the hollow bolt 12 with a force that allows the hollow bolt 12 to move slightly. This makes it easier to finely adjust the position of the stator 5 integrated with the hollow bolt 12. In addition, by providing the pressurizing mechanism 20, the tip of the hollow bolt 12 is pressed against the base part 100 even when the base end side of the position adjustment mechanism 10 is positioned on the lower side, as illustrated in FIG. 2C and FIG. 2D. In other words, the position and attitude of the stator 5 can be easily adjusted regardless of the attitude of the rotary encoder 1. In addition, a third washer 20c is disposed between the nut 22 and the stator 5.

### Adjustment Tool

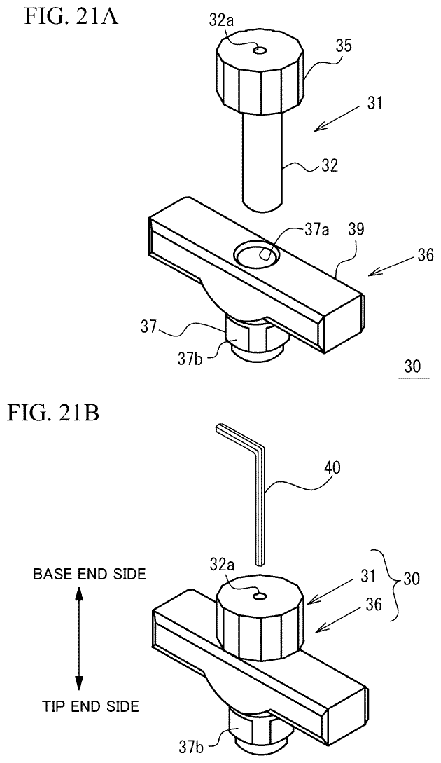

Next, an adjustment tool 30 for operating the position adjustment mechanism 10 will be described with reference to FIG. 21A to FIG. 24B. The adjustment tool 30 includes a first socket member 31 and a second socket member 36. The adjustment tool 30 is used by combining the first socket member 31 and the second socket member 36. The adjustment tool 30 can also be used by combining a hexagonal wrench 40. The first socket member 31 includes the first columnar portion 32. The first

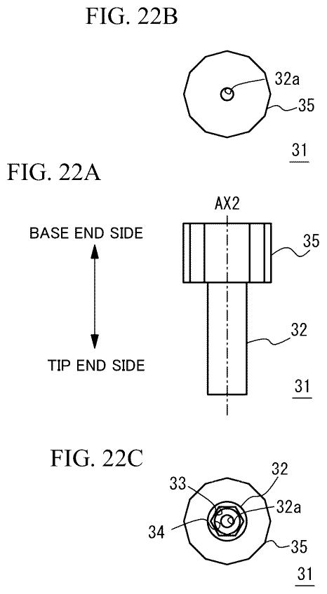

columnar portion 32 is hollow and includes a through hole 32a. As illustrated in FIG. 24B, the hexagonal wrench 40 is inserted into the through hole 32a. The first columnar portion 32 includes the first fitting portion 33 at its tip into which the head 13 of the hollow bolt 12 fits. The first fitting portion 33 communicates with the through hole 32a and has a shape that corresponds to the shape of the head 13. In this embodiment, the first fitting portion 33 is hexagonal. The first columnar portion 32 is provided with a head storage portion 34 for storing the head 18 of the fixing screw 17 on the base end side of the first fitting portion 33. The fixing screw 17 reaches the head 18 through the through hole 32a and is rotated by the hexagonal wrench 40 fitted into the tool hole 18a (see FIG. 19B). The first socket member 31 is provided with a rotation operation portion 35 at the end on the base end side. As illustrated in FIG. 22B, the rotation operation portion 35 is provided with a regular dodecagonal shape in a plan view. The shape of the rotation operation portion 35 is not limited to a regular dodecagon and can be appropriately selected in consideration of the operability of the operator. The rotation operation portion 35 may be, for example, a lever-shaped portion, but is preferably circular or a polygonal shape close to a circle.

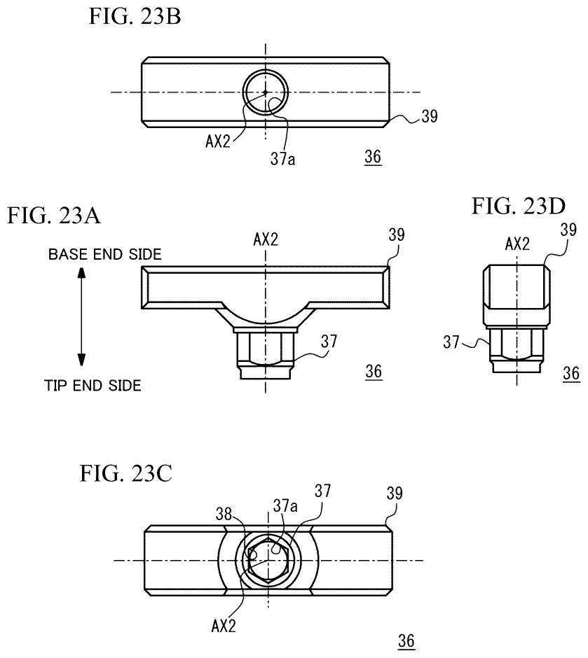

The second socket member 36 is provided with the second columnar portion 37. The second columnar portion 37 is hollow and has a through hole 37a. The first columnar portion 32 of the first socket member 31 is inserted into the through hole 37a. The first columnar portion 32 and the second columnar portion 37 are coaxially rotatable relative to each other. The second columnar portion 37 has the second fitting portion 38 into which the nut 22 fits at its tip. The second fitting portion 38 is in communication with the through hole 37a and has a shape corresponding to the shape of the nut 22. The second fitting portion 38 in this embodiment is hexagonal. The second socket member 36 has a handle portion 39 on the base end side of the second columnar portion 37. The handle portion 39 extends in a direction orthogonal to the axial direction of the second columnar portion 37. In the front view illustrated in FIG. 23A, the handle portion 39 in this embodiment extends on both sides of the second columnar portion 37 and forms a T-shape together with the second columnar portion 37. The shape of the handle portion 39 is not limited to a T-shape and may be another shape. However, considering that the second socket member 36 is used in combination with the first socket member 31, it is desirable that the handle portion 39 has a shape that protrudes laterally beyond the rotation operation portion 35. A tool fitting portion 37b is formed on the outer peripheral surface of the second columnar portion 37. The tool fitting portion 37b has four smooth surfaces formed by shifting by 90°. The second socket member 36 can also be operated by fitting another tool, such as a wrench, into the tool fitting portion 37b. By using the other tool, the nut 22 can be tightened. In addition, for example, by using a torque wrench, the tightening torque can be managed.

### Position Adjustment Work

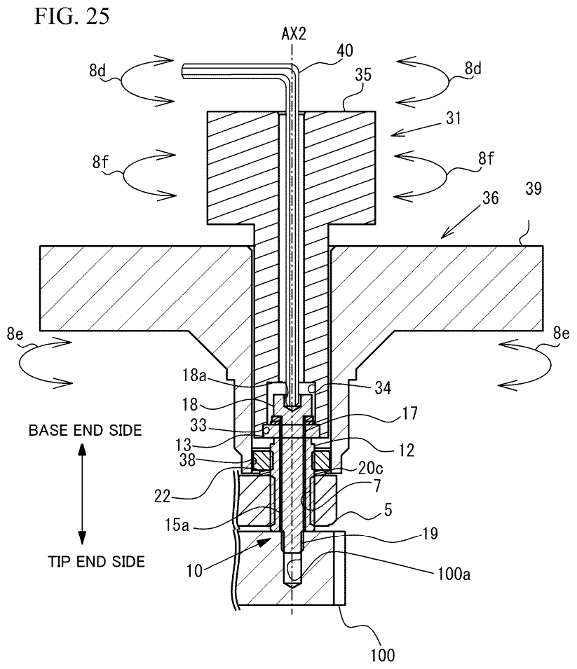

Next, the work of adjusting the position of the stator 5 by operating the position adjustment mechanism 10 using the adjustment tool 30 will be described with reference to FIG. 25. The position adjustment mechanisms 10 are installed at three locations on the stator 5, and position adjustment is performed at each of the position adjustment mechanisms 10. In the following description, the adjustment work at one of the position adjustment mechanism 10 will be described. The operator can perform the adjustment work based on instructions from the mounting support device 51.

Referring to FIG. 25, the stator 5 is attached to the base part 100 by the position adjustment mechanism 10. Specifically, the inner peripheral screw portion 7 of the stator 5 is screwed into the outer peripheral screw portion 15a of the hollow bolt 12 into which the fixing screw 17 is inserted, and the hollow bolt 12 does not rotate due to the nut 22. The screw portion 19 of the fixing screw 17 is fastened to the screw hole 100a of the base part 100, so that the movement in the X, Y, and Z directions is restricted and fixed.

The first socket member 31 and the second socket member 36 of the adjustment tool 30 are attached to the position adjustment mechanism 10. The head 18 of the fixing screw 17 is stored in the head storage section 34. The hexagonal wrench 40 fits into the tool hole 18a provided in the head 18 of the fixing screw 17. This allows the fixing screw 17 to rotate as illustrated by an arrow 8d, and the fixing screw 17 can be in a fastened or loosened state. The second socket member 36 also allows the nut 22 to be in a fastened or loosened state. Fastening the fixing screw 17 and the nut 22 can prevent the hollow bolt 12 from rotating. After completing the position adjustment of the stator 5, the position adjustment mechanism 10 is in a state in which the fixing screw 17 is fastened. The rotary encoder 1 is used with the fixing screw 17 fastened. Loosening the fixing screw 17 and the nut 22 can make the hollow bolt 12 rotatable. When adjusting the position of the stator 5, the fixing screw 17 and the nut 22 are loosened. The hollow bolt 12 can be rotated by loosening the fixing screw 17 and the nut 22. The position of the stator 5 in the Z direction can be adjusted by rotating the hollow bolt 12.

In this embodiment, the outer diameter R19 of the screw portion 19 and the inner diameter r14a of the inner peripheral surface 14a of the hollow cylindrical portion 14 have a relationship of the outer diameter R19<the inner diameter r14a. Therefore, by loosening the fixing screw 17, the stator 5 can be moved in the X direction or the Y direction with respect to the central axis AX2 of the screw hole 100a.

The second fitting portion 38 is fitted to the nut 22. As a result, by operating the second socket member 36, the nut 22 can be rotated as illustrated by an arrow 8e. The nut 22 is screwed onto the outer peripheral screw portion 15a of the hollow bolt 12. The nut 22 descends relative to the hollow bolt 12 and is fastened to the stator 5 via the third washer 20c, thereby making it possible to fix the stator 5 to the hollow bolt 12. Here, the nut 22 descending relative to the hollow bolt 12 means that the nut 22 moves toward the tip side of the hollow bolt 12.

The first fitting portion fits into the head 13 of the hollow bolt 12. As a result, by operating the first socket member 31, the hollow bolt 12 can be rotated as illustrated by an arrow 8f. The inner peripheral screw portion 7 of the stator 5 is screwed into the outer peripheral screw portion 15a of the hollow bolt 12. The stator 5 itself is attached to the base part 100 at three points. Therefore, the stator 5 does not rotate together with the rotation of the hollow bolt 12 in each of the position adjustment mechanisms 10. When the hollow bolt 12 rotates, the location where the position adjustment mechanism 10 is installed on the stator 5 moves up and down. By adjusting the height position at the location where the position adjustment mechanism 10 is installed on the stator 5, the relative positional relationship between the rotation axis and the stator 5 can be adjusted, and as a result, the stator 5 can be installed on a vertical plane of the rotation axis.

As described above, the position adjustment mechanism 10 includes three fasteners: the hollow bolt 12, the fixing screw 17, and the nut 22. For this position adjustment mechanism 10, the adjustment tool 30 includes the first socket member 31 and the second socket member 36, which are combined to be rotatable on the same axis. Furthermore, the adjustment tool 30 includes the through hole 32a into which the hexagonal wrench 40, which is another tool installed on the same axis as the first socket member 31 and the second socket member 36, is inserted. Therefore, the position adjustment mechanism 10 can be easily operated by using the adjustment tool 30.

When the operator holds the handle portion 39, the first columnar portion 32 is inserted into the second columnar portion 37. The hexagonal wrench 40 is inserted into the through hole 32a. Therefore, the first socket member 31 is mounted on the second socket member 36 and will not fall off the second socket member 36. In addition, the hexagonal wrench 40 will not fall off the adjustment tool 30.

The operator can hold the three tools, that is, the first socket member 31, the second socket member 36, and the hexagonal wrench 40 included in the adjustment tool 30, with one hand. This eliminates the need to switch between general tools such as a conventional wrench, and shortens the work time. In this way, the three tools can be held with one hand, and the other hand can operate the required tool at the required time. Furthermore, the hollow bolt 12, the fixing screw 17, and the nut 22 can be easily accessed, making the work easier.

As an example of the work method, for example, the operator can hold the handle portion 39 of the second socket member 36 so that it is supported by the middle finger, the ring finger, and the palm. In this state, the operator can freely use his thumb and index finger. Therefore, the operator can use his thumb and index finger to rotate the rotation operation portion 35 of the first socket member 31 and the hexagonal wrench 40. The operator can operate the second socket member 36 by bending the wrist toward the palm side or the back side or by moving the whole arm while gripping the handle portion 39. The operator only needs to operate the part that is engaged with the fastener to be rotated. When the operator wants to rotate the nut 22, the operator only needs to rotate the second socket member 36 without touching the first socket member 31 or the hexagonal wrench 40. When the operator wants to rotate the hollow bolt 12, the operator only needs to rotate the first socket member 31 without rotating the second socket member 36 or touching the hexagonal wrench 40. When the operator wants to rotate the fixing screw 17, the operator only needs to rotate the hexagonal wrench 40 without rotating the second socket member 36 or touching the first socket member 31.

The operator can work in a way that is easy for him/her to operate. By using the adjustment tool 30, the operator can easily perform the adjustment work when the rotor 2, the stator 5, and the base part 100 are in a horizontal position or in an upside-down environment as illustrated in FIG. 2C and FIG. 2D.

If the adjustment tool 30 is not used, the operator has to operate a hexagonal wrench for the fixing screw 17, a spanner for the hollow bolt 12, and a spanner for the nut 22. It is very difficult for one operator to operate these multiple tools at the same time. In addition, the handle of a spanner is long, making it difficult to work in a narrow space. By using the adjustment tool 30 of this embodiment, one operator can easily operate the position adjustment mechanism 10. In addition, the adjustment tool 30 is used in a state where it is coaxially capped with the position adjustment mechanism 10, making it easy to work in a narrow space.

### Mounting Work (Mounting Support)

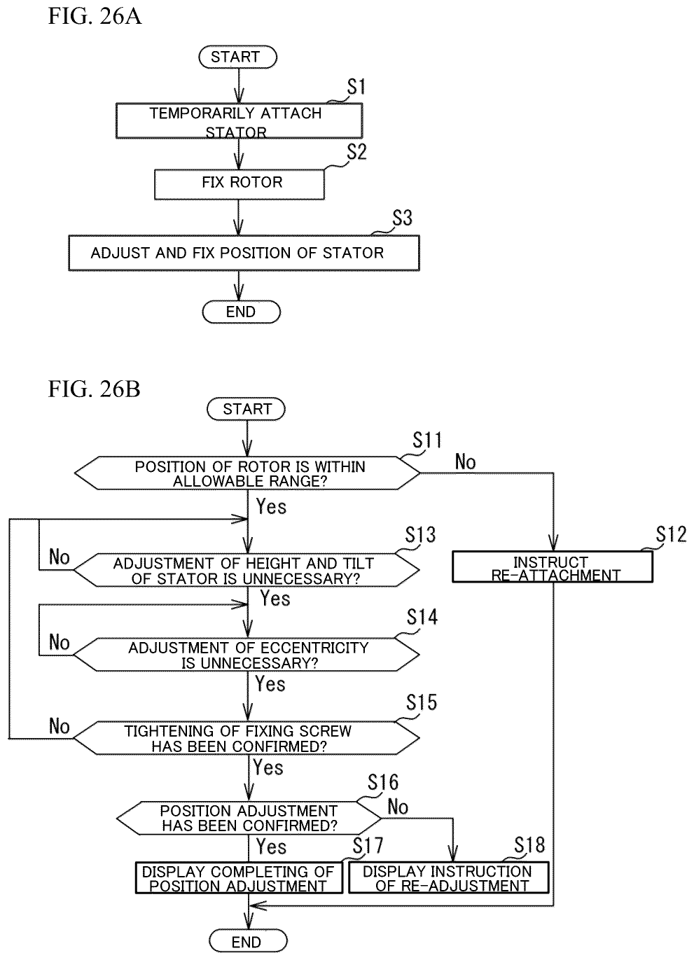

Next, an example of the mounting work of the rotary encoder I using the mounting support device 51 will be described with reference to FIG. 26A to FIG. 30.

First, according to the flow chart illustrated in FIG. 26A, the stator 5 is temporarily mounted to the base part 100 (step S1) and the rotor 2 is fixed to the device rotating shaft member 101 (step S2). The stator 5 is temporarily mounted to the base part 100 using the position adjustment mechanism 10. Specifically, the outer peripheral screw portion 15a of the hollow bolt 12 is screwed into the inner peripheral screw portion 7 provided in the mounting hole 6 of the stator 5. Furthermore, the fixing screw 17 is screwed into the screw hole 100a of the base part 100. However, at this time, the fixing screw 17 is not completely tightened, and the stator 5 is left in a state where it can move within the XY plane. The position adjustment mechanism 10 includes the pressurizing mechanism 20. This causes the tip of the hollow bolt 12 to be pressed against the base part 100. This facilitates fine adjustment of the position and attitude of the stator 5.

As illustrated in FIG. 2A, the rotor 2 is fixed by fitting a step 101a formed at the end of the device rotation shaft member 101 into the fitting hole 2a. In this embodiment, the stator 5 is located on the lower side in the Z-axis direction, and the rotor 2 is located above the stator 5, so that the temporary attachment of the stator 5 is performed prior to the fixing of the rotor 2. Depending on the positional relationship between the stator 5 and the rotor 2, the order of steps SI and S2 may be reversed.

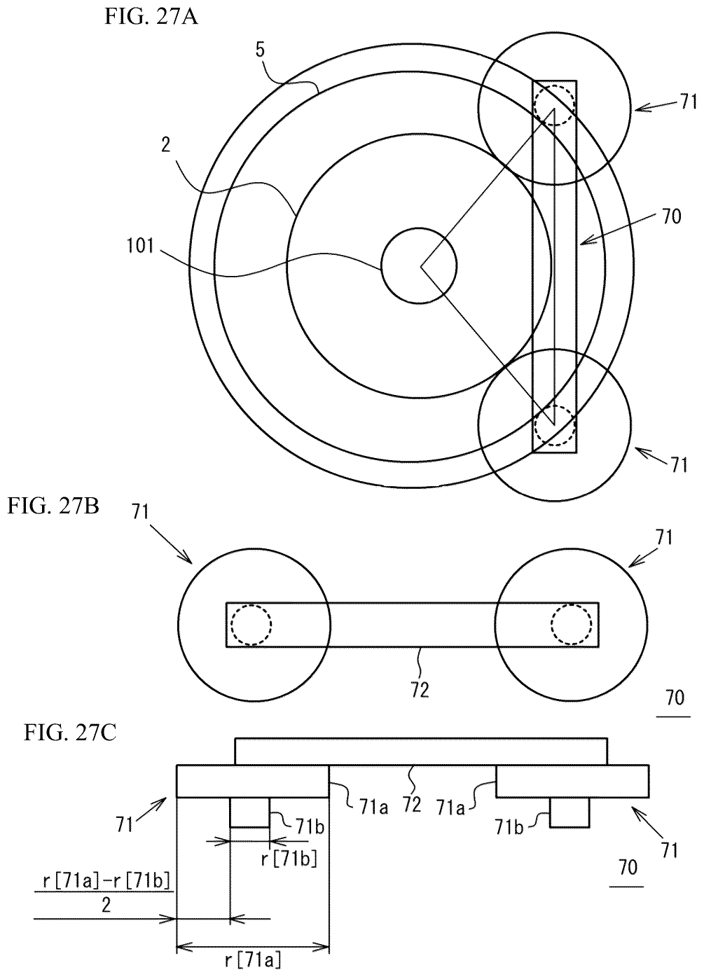

In step S3, which is performed following steps S1 and S2, eccentricity adjustment of the stator 5 is performed. The eccentricity adjustment in step S3 may be a simple adjustment that roughly corrects the eccentricity. Specifically, the stator 5 may be adjusted to within a range in which the detection value can be obtained by the detection head facing the rotor 2. For example, the eccentricity is provisionally aligned and fixed based on the outer peripheral wall of the rotor 2 and the outer peripheral wall of the stator 5. At this time, the eccentricity can be adjusted using a positioning jig 70 arranged so as to be in contact with the outer peripheral wall of the rotor 2 and the outer peripheral wall of the stator 5, as illustrated in FIG. 27A.

With reference to FIG. 27B and FIG. 27C, the positioning jig 70 has two contact portions 71. The two contact parts 71 are attached to both ends of a connecting member 72. Each of the contact portions 71 has a first cylindrical portion 71a that contacts the outer peripheral wall of the rotor 2, and a second cylindrical portion 71b that contacts the outer peripheral wall of the stator 5.

The diameter of the first cylindrical portion 71a is r[71a], and the diameter of the second cylindrical portion 71b is r[71b]. r[71a] and r[71b] are set so that the value of (r[71a]-r[71b])/2 is equal to the difference between the radius of the rotor 2 and the radius of the stator 5.

The positioning jig 70 is set so that the first cylindrical portion 71a contacts the outer peripheral surface of the rotor 2, and the second cylindrical portion 71b contacts the outer peripheral surface of the stator 5, at the two contact portions 71. This allows for rough eccentricity adjustment of the stator 5.

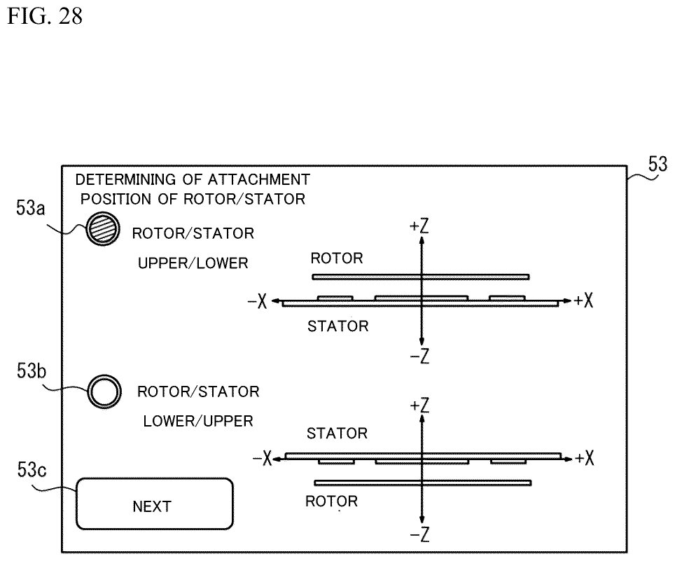

Once the rotor 2 has been fixed and the stator 5 has been temporarily attached as described above, the mounting work begins using the mounting support device 51. The operator first checks that the first connector 58 and the second connector 59 are connected, and once the connection is confirmed, the operator starts up the mounting support device 51 and launches the mounting support program. When the mounting support program launches, the displayer 53 first displays the screen illustrated in FIG. 28. FIG. 28 illustrates an example of a screen for confirming “Rotor/Stator Installation Position Designation”. In this embodiment, the relative positions of the rotor 2 and the stator 5 are adjusted by adjusting the position of the stator 5. Therefore, if the arrangement of the rotor 2 and the stator 5 is different, the movement direction of the stator 5 will be different. Therefore, the mounting support program first has the operator specify the relationship between the installation positions of the rotor 2 and the stator 5 so that the visual information of the operator matches the movement direction of the stator 5 displayed on the displayer 53. For example, when the rotor 2 is located on the upper side and the stator 5 is located on the lower side, a button 53a is selected.

Conversely, when the rotor 2 is located on the lower side and the stator 5 is located on the upper side, a button 53b is selected. The operator who has made the selection presses, for example, a button 53c which displays “Next”. When the button 53c is pressed, the CPU 52 which executes the mounting support program proceeds to step S11 in the flowchart exemplified in FIG. 26B. This allows the operator to match the instructed moving direction of the stator 5 and the position of the position adjustment mechanism 10 with his or her own sense in the subsequent work, making it easier to perform the position adjustment work.

In step S11, the CPU 52 determines whether the position of the rotor 2 fixed to the device rotation shaft member 101 is within the allowable range. The determination in step S11 is made, for example, based on the path of the eccentricity and tilt traced by rotating the rotor 2 once. When the rotor 2 rotates once, the eccentricity and the tilt trace a path that is close to a circle. This path corresponds to the eccentricity and the tilt of the rotor 2. Note that this path can be approximated to a circle, making it possible to calculate the eccentricity and the tilt even when the rotor 2 has not yet completed one rotation.

The CPU 52 determines whether the eccentricity and the tilt of the rotor 2 calculated as described above are within the allowable range. Here, the allowable range is a predetermined fitting tolerance between the rotor 2 and the device rotation shaft member 101, which is set in advance, more specifically, the range of the eccentricity and the tilt when the device rotation shaft member 101 is within a predetermined tolerance with respect to the device rotation axis AX1, and the fitting tolerance of the mounting part of the rotor 2 is observed.

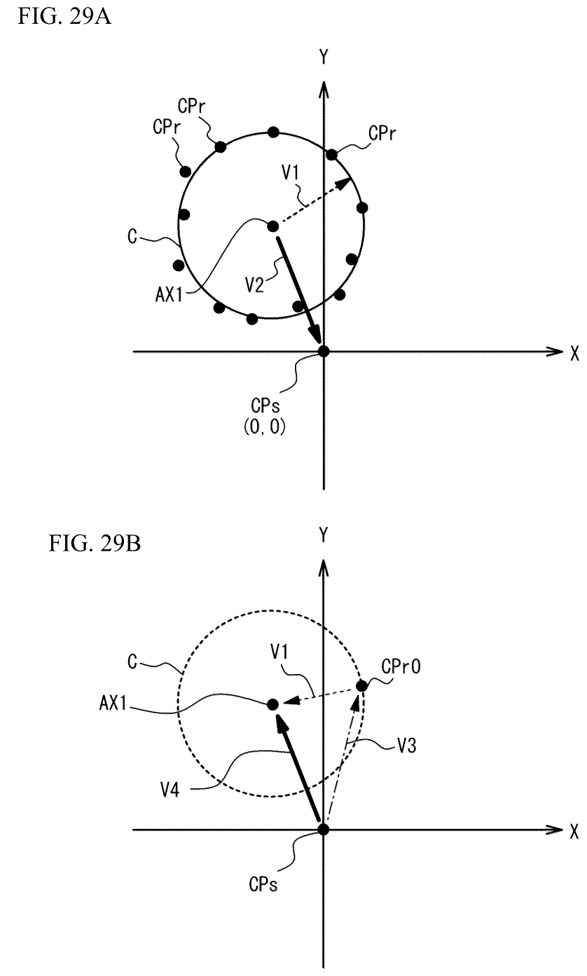

Now, with reference to FIG. 29A, the calculation of the amount and direction of eccentricity of the rotor 2 and the amount and direction of eccentricity of the stator 5 will be described. FIG. 29A assumes that the rotor 2 is eccentric with respect to the device rotation axis AX1. The symbol CPs illustrated in FIG. 29A indicates the center point of the stator 5. The detection value acquired by the rotation of the rotor 2 is detected by the stator 5, so the coordinates of the center point CPs of the stator 5 are (0,0). In FIG. 29A, when the rotor 2 rotates and acquires its position discretely, multiple center points CPr of the rotor 2 are drawn. In addition, in FIG. 29A, an arc C is drawn by approximating the position data of the multiple center points CPr using, for example, the least squares method. The center point of this arc C corresponds to the device rotation axis AX1. The radius of the arc C indicated by the arrow V1 corresponds to the average value of the eccentricity of the rotor 2. By knowing the coordinates of the device rotation axis AX1, the amount and direction of eccentricity of the stator 5 can be known as indicated by the arrow V2. Note that the eccentricity direction of the rotor 2 at this stage is a value that corresponds one-to-one with one of the detection values (θz) of the rotary encoder 1.

As described above, the amount and direction of eccentricity can be obtained, and the amount and direction of tilt of the rotor 2 can also be calculated in a similar manner. In other words, by replacing the measured values (X, Y) with the measured values (θx, θy) and performing the same calculation, the amount and direction of tilt of the rotor 2 can be calculated.

The amount of eccentricity and tilt of the rotor 2 calculated in this manner are used in step S11. That is, in step S11, it is determined whether the calculated amount of eccentricity and tilt of the rotor 2 are within the allowable range.

If the CPU 52 makes a negative determination (No determination) in step S11, the process proceeds to step S12. In step S12, the CPU 52 issues an instruction to re-install the rotor 2. The re-installation is performed again based on the flowchart illustrated in FIG. 26A. After the instruction to re-install the rotor 2 is issued, the process ends once, and after the re-installation is performed, the process from step S11 is performed. Note that instead of issuing an instruction to re-install, an instruction to perform adjustment using the rotor adjustment mechanism may be issued.

If the CPU 52 makes a positive determination (Yes determination) in step S11, the process proceeds to step S13. In step S13, the CPU 52 determines whether the height and tilt of the stator 5 are within the allowable range. Here, the height is the distance between the stator 5 and the rotor 2. The height and tilt of the stator 5 are adjusted at three locations where the position adjustment mechanisms 10 are arranged. If the heights at these three points are different, the stator 5 is tilted.

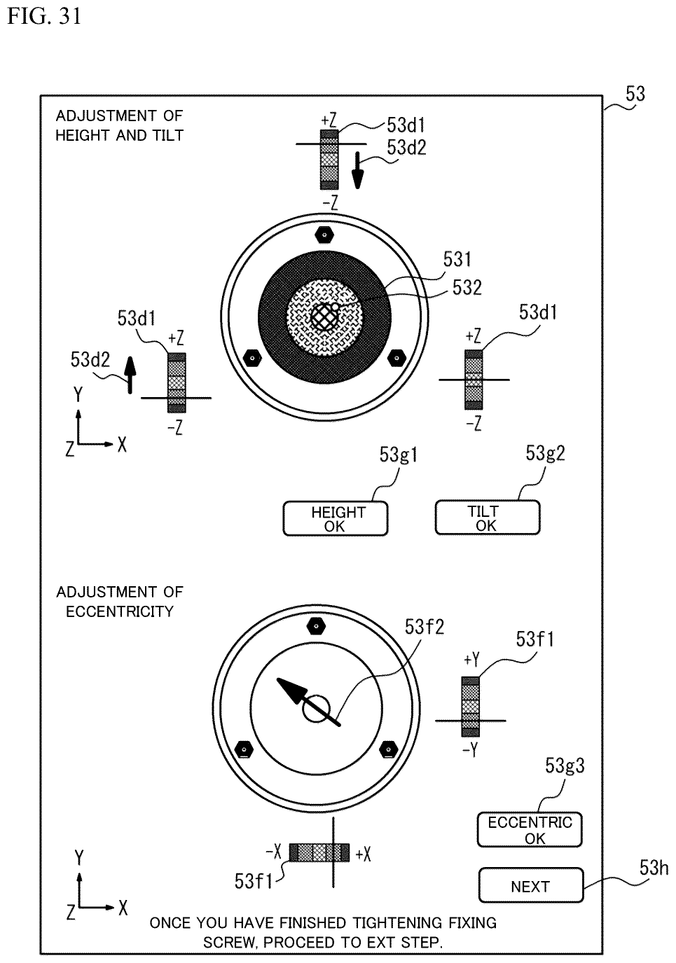

If the CPU 52 makes a positive determination in step S13, the process proceeds to step S14. In step S14, the CPU 52 determines whether the eccentricity of the stator 5 is within the allowable range. The eccentricity is the amount of deviation of the stator 5 from the device rotation axis AX1 of the device rotation shaft member 101 to which the rotor 2 is fixed. The eccentricity is divided into a component along the X-axis direction and a component along the Y-axis direction. Note that, for safety reasons, the processing from step S12 to step S15 is performed while the rotation of the rotor 2 is stopped. Furthermore, while the processing from step S13 to step S15 is being executed, the displayer 53 displays the display illustrated in FIG. 31 as an example. That is, in the process from step S13 to step S15, the heights of the three positions where the position adjustment mechanism 10 is disposed, the tilt of the stator 5, and the eccentricity of the stator 5 are displayed in real time, and the operating state of the position adjustment mechanism 10 by the operator is reflected and displayed in real time.

Now, with reference to FIG. 29B, the amount and direction of eccentricity of the stator 5 will be described. The arc C illustrated in FIG. 29B is the same as the arc C illustrated in FIG. 29A, but this arc C is the arc in the state in which a positive determination is made in step S11. The adjustment of the stator 5 is performed with the rotation of the rotor 2 stopped. Therefore, only one center point coordinate CPr0 of the rotor 2 indicated by the arrow V3 can be obtained from the detection value of the stator 5. This center point coordinate CPr0 can be considered to exist on the arc C. From CPr0, the position of the device rotation axis AX1 can be obtained by V1 associated with the rotation angle θz. That is, the amount and direction of eccentricity between the center point CPs of the stator 5 and the device rotation axis AX1 can be indicated by V4, which is a combination of V3 and V1. The position of the device rotation axis AX1 can be obtained from CPr0 by V1 associated with the rotation angle θz. The eccentricity adjustment work of the stator 5 is the work of shortening this arrow V4. As will be described later, the CPU 52 displays the amount and direction of eccentricity indicated by the arrow V4 on the displayer 53.

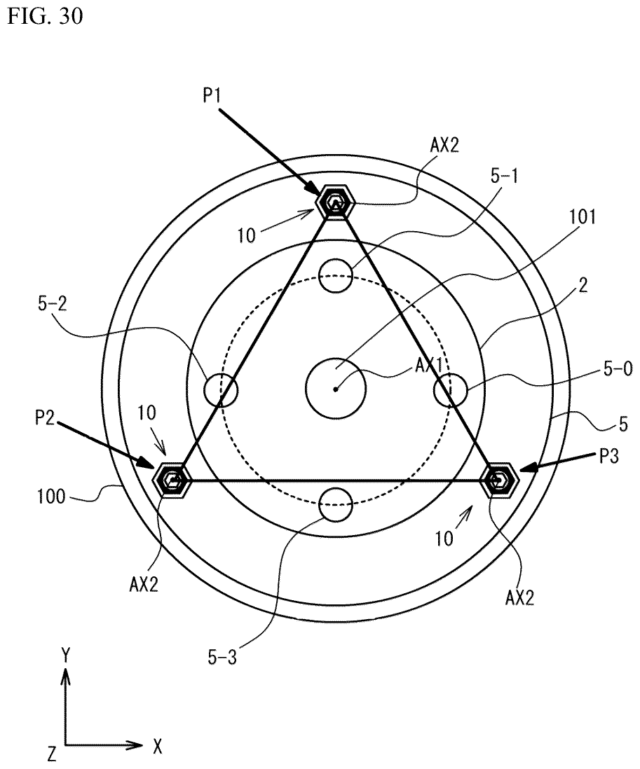

Next, the height of the stator 5 will be described with reference to FIG. 30. FIG. 30 illustrates the relationship between the arrangement positions of the four detection heads 5-0 to 5-3 and the arrangement positions P1, P2, and P3 of the three position adjustment mechanisms 10. In this embodiment, the average value of the detection distances of the four detection heads 5-0 to 5-3 is set as the height (gap) at the center point CPs of the stator 5. Here, the mutual distances between the four detection heads 5-0 to 5-3 and the three position adjustment mechanisms 10 are known. Furthermore, the amount of tilt (θx, θy) of the stator 5 is acquired by the rotary encoder 1. Therefore, the height of the stator 5 at the three locations where the position adjustment mechanisms 10 are provided can be calculated based on the height at the center point CPs and the amount of tilt (θx, θy) of the stator 5. The height and tilt adjustment work of the stator 5 is a work of adjusting the heights of the three locations where the position adjustment mechanisms 10 are provided to the same desired height. The CPU 52 causes the displayer 53 to display the heights of the three locations where the position adjustment mechanisms 10 are provided, as will be described later.

The CPU 52 displays an indicator 53d1 and an arrow 53d2 on the displayer 53, as illustrated in FIG. 31. The CPU 52 also displays an indicator 53f1 and an arrow 53f2 on the displayer 53.

The indicator 53d1 indicates the height of the stator 5 at the position where the position adjustment mechanism 10 is disposed. Specifically, the indicator 53d1 indicates whether the current height position of the stator 5 is above or below the appropriate position based on the detection value detected by the detection head, and indicates the degree of deviation from the appropriate position. The height position of the stator 5 is the distance between the stator 5 and the rotor 2. The display format of the indicator 53d1 can be changed as appropriate. The indicator 53d1 of this embodiment is divided into multiple areas in the vertical direction, and indicates the current position of the stator 5. The arrow 53d2 indicates the direction in which the operator should move the stator 5. For example, if the stator 5 is in a position higher than the appropriate position, the indicator 53d1 indicates that the stator 5 is in a high position, and the arrow 53d2 points downward to indicate the direction in which to move the stator 5.

For tilt, as illustrated in FIG. 31, three concentric circles 531 are displayed, within which are displayed indicator points 532 indicating the direction and degree of tilt. The indicator points 532 indicate which direction of the stator 5 is high, and further, how high. The center point of the concentric circles 531 indicates the appropriate position for the tilt of the stator 5. Therefore, the position of the indicator point 532 within the concentric circles 531 indicates the degree of deviation from the appropriate position. In other words, the direction of the indicator point 532 relative to the center point of the concentric circles 531 indicates which direction of the stator 5 is high. Furthermore, the distance of the indication point 532 from the center point of the concentric circle 531 indicates the degree to which the stator 5 is tilted; the further away from the center point of the concentric circle 531 the more the stator 5 is deviated from the correct position. The arrow 53d2 displayed on the indicator 53d1 also indicates the direction in which the tilt will be eliminated.

When the operator operates the position adjustment mechanism 10 in accordance with the mounting support device 51 and it is determined that the height and tilt of the stator 5 are within the allowable range, the displayer 53 displays 53g1 “Height OK” and 53g2 “Tilt OK”. When these displays are displayed, a positive determination is made in step S13. When a negative determination is made in step S13, the process of step S13 is repeated, and when a positive determination is made in step S13, the process proceeds to step S14.

The indicator 53f1 is displayed in two places, one of which indicates the direction and amount of eccentricity along the X-axis direction, and the other of which indicates the direction and amount of eccentricity along the Y-axis direction. Specifically, one of the indicators 53f1 indicates whether the current position of the stator 5 along the X-axis direction is in the + or − direction with respect to the appropriate position based on the detection value detected by the detection head, and indicates the degree of deviation from the appropriate position. The other of the indicators 53f1 indicates whether the current position of the stator 5 along the Y-axis direction is in the + or-direction with respect to the appropriate position based on the detection value detected by the detection head, and indicates the degree of deviation from the appropriate position. The display format of the indicator 53d1 can be changed as appropriate. The indicator 53f1 of this embodiment is divided into multiple areas in the X-axis or Y-axis direction, and the current position of the stator 5 is displayed. The arrow 53f2 indicates the direction in which the operator should move the stator 5. For example, if the stator 5 is eccentric to the + side of the appropriate position along the X-axis and to the-side of the appropriate position along the Y-axis, the arrow 53f2 points in a direction that counteracts this, and indicates the direction in which to move the stator 5.

The operator operates the second socket member 36 of the adjustment tool 30 to rotate the hollow bolt 12 and move the stator 5 in the direction indicated by the arrow 53d2. If the indicator 53d1 shows that it is in the appropriate position, the adjustment at that location is complete. The operator also moves the stator 5 in the direction indicated by the arrow 53f2. If the indicator 53f1 shows that it is in the appropriate position, the adjustment at that location is complete. When the operator completes the adjustment of the height position of the stator 5 at all three locations and the two indicators 53f1 are in the appropriate positions, the “eccentricity OK” display 53g is displayed. When this display is displayed, a positive determination is made in step S14. If a negative determination is made in step S14, the process of step S14 is repeated, and if a positive determination is made in step S14, the process proceeds to step S15.

In the flowchart illustrated in FIG. 26B, the process of step S14 is executed after the process of step S13, but the order of these processes may be reversed, or they may be executed simultaneously.

If the CPU 52 makes a positive determination in step S14, that is, if the determinations of both step S13 and step S14 are positive, the CPU 52 proceeds to step S15. At this time, an instruction to tighten the fixing screw 17 is issued on the displayer 53. The tightening instruction displayed on the displayer 53 may be, for example, an indication such as “Once tightening of the fixing screw is completed, proceed to the next step” as illustrated in FIG. 31. The operator tightens the fixing screw 17 according to the tightening instruction. When tightening of the fixing screw 17 is completed, the operator presses a button 53h indicated as “Next” displayed on a displayer 23. When the button 53h is pressed, a positive judgment is made in step S15.

The process in step S15 becomes a positive judgment when the button 53h is pressed. Therefore, until the button 53h is pressed, a negative judgment is made in step S15. In other words, when the fixing screw 17 is tightened, the judgment functions of steps S13 and S14 are in operation. In other words, even if step S15 is reached once, if the judgment of either step S13 or step S14 becomes a negative judgment during the period until a positive judgment is made in step S15, the display will be switched to one instructing adjustment. If the tightening of the fixing screw 17 is completed without a display instructing adjustment being displayed and the operator is able to press the “Next” button 53h, the CPU 52 proceeds to S16.

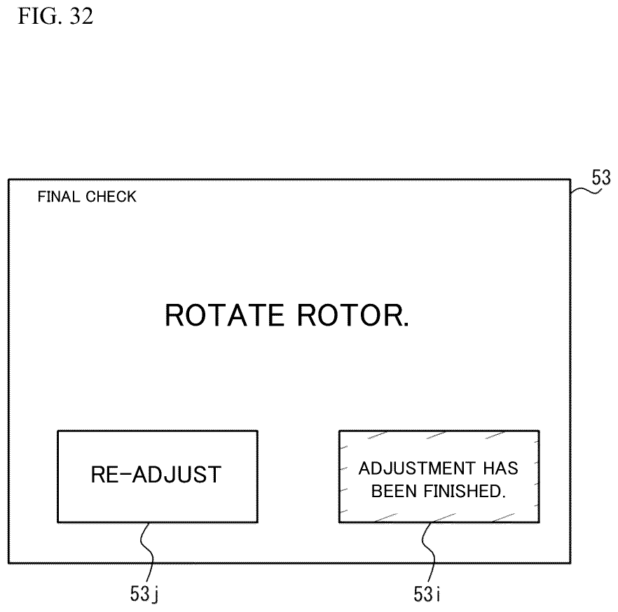

In step S16, the CPU 52 rotates the rotor 2 and judges again whether the stator 5 and the rotor 2 are attached in the desired state. Specifically, the CPU 52 displays a display as illustrated in FIG. 32 on the displayer 53. For example, a message encouraging the rotation of the rotor 2 is displayed on the displayer 53. When the operator rotates the rotor 2 in accordance with this message, the CPU 52 again determines whether the stator 5 and the rotor 2 are positioned properly based on the detection value of the detection head. If the stator 5 and the rotor 2 are positioned properly, the CPU 52 makes a positive determination in step S16 and proceeds to step S17. On the other hand, if the stator 5 and the rotor 2 are not positioned properly, the CPU 52 makes a negative determination in step S16 and proceeds to step S18.

In step S17, the CPU 52 displays a display 53i on the displayer 53 indicating that the adjustment has been completed. This completes the position adjustment of the stator 5 and the installation of the rotary encoder 1.

Meanwhile, in step S18, the CPU 52 displays on the displayer 53 a display 53j indicating that further adjustment should be performed. This temporarily ends the position adjustment of the stator 5 and the attachment of the rotary encoder 1. However, since the stator 5 and the rotor 2 are not positioned in the appropriate position, the operator performs the position adjustment work again. Note that the mounting support device 51 may display information after step S18 as to whether the height position of the stator 5 is still not appropriate or whether it is eccentric. Based on this information, the operator can know the items that need to be adjusted.

In this embodiment, the direction and amount of eccentricity of the stator 5 can be known based on the detection value of the detection head, and the position adjustment of the stator 5 can be easily performed based on this information.

The present invention is not limited to the specifically disclosed embodiments and variations but may include other embodiments and variations without departing from the scope of the present invention.

what is claimed is:

1. A mounting method of a rotary encoder for mounting the rotary encoder to a device including a device body and a device rotation shaft member rotatably provided with respect to the device body, the method comprising:
temporarily attaching a stator included in the rotary encoder to the device body;
fixing a rotor included in the rotary encoder to the rotation shaft member of the device so as to face the stator;
acquiring a distance between the rotor and the stator,
rotating the rotor and acquiring an amount of eccentricity, an eccentric direction, an amount of tilt, and a direction of tilt of the rotor with respect to a device rotation axis, which is a rotation axis of the device rotation shaft member, based on a detection value detected by a detection head provided on the stator;
rotating the rotor and acquiring an amount of eccentricity, an eccentric direction, an amount of tilt, and a direction of tilt of the stator with respect to the device rotation axis, based on the detection value detected by the detection head provided on the stator;
determining whether the amount of eccentric and the amount of tilt of the rotor are within an allowable range;
moving the stator with respect to the device rotation axis so that the amount of eccentric of the stator is within the allowable range; and
moving the stator so that the distance between the stator and the rotor at a position where the rotor is attached to the device body, and the amount of tilt and the direction of tilt with respect to the device rotation axis are within the allowable range.

2. The method as claimed in claim 1,
wherein the stator is temporarily attached at positions equally spaced circumferentially of the stator using a position adjustment mechanism, and
wherein the position adjustment mechanism includes a bolt having an outer peripheral screw portion on an outer peripheral surface of a shaft that screws into an inner peripheral screw portion provided in a mounting hole in the stator, a nut that screws into the outer peripheral screw portion, and a fixing screw that is inserted through the shaft and screwed into the device body.

3. A computer-readable, non-transitory medium storing a program for supporting in adjusting positions of a rotor and a stator disposed opposite the rotor, when attaching a rotary encoder to a device having a device body and a device rotation shaft member rotatably provided with respect to the device body, the program causing a computer to execute a process, the process comprising:
calculating a distance between the rotor and the stator,
calculating an amount of eccentricity, an eccentric direction, an amount of tilt, and a direction of tilt of the rotor with respect to a device rotation axis, which is a rotation axis of the device rotation shaft member, based on a detection value detected by a detection head provided on the stator, when rotating the rotor fixed to the device rotation shaft member;
calculating an amount of eccentricity, an eccentric direction, an amount of tilt, and a direction of tilt of the stator with respect to the device rotation axis, based on the detection value detected by the detection head provided on the stator, when rotating the rotor fixed to the device rotation shaft member;
displaying the amount of the eccentric and the direction of eccentric of the stator with respect to the device rotation axis on a displayer; and
displaying the distance between the stator and the rotor at a position where the stator is attached to the device body on the displayer and displaying the amount of tilt and the direction of tilt with respect to the device rotation axis.

4. The medium as claimed in claim 3,
wherein the process comprises:
displaying a direction in which the stator is to be moved so that an eccentricity of the stator with respect to the device rotation axis falls within an allowable range.

5. The medium as claimed in claim 3,
wherein the process comprises:
displaying the distance between the stator and the rotor, and a direction in which the stator is to be moved so that the amount of tilt and the direction of tilt with respect to the device rotation axis are within an allowable range.

6. A mounting support device that supports in adjusting a position of a rotor included in a rotary encoder and a stator arranged opposite the rotor when mounting the rotary encoder on a device having a device body and a device rotation shaft member rotatably arranged with respect to the device body, comprising:
an information processor configured to calculate a distance between the rotor and the stator, and calculate an amount of eccentricity, an eccentric direction, an amount of tilt, and a direction of tilt of the rotor with respect to a device rotation axis, which is a rotation axis of the device rotation shaft member, based on a detection value detected by a detection head provided on the stator attached to the device body when the rotor fixed to the device rotation shaft member is rotated, and calculate an amount of eccentricity, an eccentric direction, an amount of tilt, and a direction of tilt of the stator with respect to the device rotation axis, based on the detection value detected by the detection head provided on the stator attached to the device body when the rotor fixed to the device rotation shaft member is rotated; and
a displayer configured to display the amount of eccentricity and the eccentric direction of the stator with respect to the device rotation axis calculated by the information processor, the distance between the stator and the rotor at a position where the stator is attached to the device body, and the amount of tilt and the direction of tilt with respect to the device rotation axis.

7. The mounting support device as claimed in claim 6, further comprising:
a connector member capable of connecting to or disconnecting from a calculator included in the rotary encoder.
